(19) United States
(12) Patent Application Publication
(10) Pub. No.: US 2026/0039381 A1
(43) Pub. Date: Feb. 5, 2026

(54) SEGMENTATION-BASED ACTIVITY DETECTION IN FIBER OPTIC NETWORK

(71) Applicant: CyberSecure Innovations, LLC, Prince Frederick, MD (US)

(72) Inventors: Bobby NAKANELUA, Elizabethtown, KY (US); Scott RYE, Prince Frederick, MD (US); Stephen SOHN, Cummings, GA (US)

(73) Assignee: CyberSecure Innovations, LLC, Prince Frederick, MD (US)

(21) Appl. No.: 18/791,309

(22) Filed: Jul. 31, 2024

(51) Int. Cl. H04B 10/079

(52) U.S. Cl. CPC H04B 10/079

(57) ABSTRACT

In some embodiments, a fiber optic cable may be monitored while reducing false positives from disturbances in trusted areas. In some embodiments, a system includes a light source, a first remote termination unit in a trusted area, and a second remote termination unit in another trusted area. The light source emits light through the fiber optic cable, which passes through the first remote termination unit, an untrusted area, and then the second remote termination unit. The remote termination units reflect portions of the light back towards the light source. The system uses a prediction model to detect disturbances in the untrusted area based on the reflected light data.

### SUMMARY

Methods and systems are described herein for improvements related to detection of activities based on monitoring cable signals (e.g., selected portions of light reflected across a fiber optic cable by one or more remote termination units).

In an environment where a monitored fiber optic cable spans between two trusted areas, the ability to determine whether human interaction or other activity occurred in trusted areas vs. untrusted areas is highly desirable. For example, standard network maintenance activities in trusted areas often resemble cable intrusions, leading to a significant number of false alarms with non-location-specific detectors. Although pre-existing systems use fiber optic cables in trusted areas that are “desensitized” or less responsive to human interaction, these cables typically utilize interlocking metal armor or rigid materials. Many segments of cable often cannot utilize rigid materials (e.g., because of the need to be able to fully extend the cable at particular locations or other reasons).

In addition, while a more sophisticated and costly detector or the introduction of sensors at specific locations of the cable may be utilized to implement location-specific detection, the former is often cost-prohibitive, and the latter is usually not feasible for cable that is already installed within an infrastructure (e.g., because incorporating sensors into cables is generally performed during the manufacturing process).

To address one or more of the foregoing issues, in some embodiments, methods and systems described herein enable area-specific or segmentation-specific detection of activities by “segregating” a fiber optic cable into one or more areas (e.g., that may be used to monitor untrusted areas between trusted areas). For example, a monitored fiber optic cable may span across two trusted areas along with an untrusted area between the two trusted areas. Two remote termination units may be respectively placed at two cable portions in the two trusted areas, where (i) the first remote termination unit in the first trusted area is configured to reflect back a first spectral portion of light and allow a second spectral portion of the light to pass through the first remote termination unit to one or more cable portions located in the untrusted area, and (ii) the second remote termination unit in the second trusted area is configured to reflect back the second spectral portion of the light. Based on the foregoing arrangement, the system may use the reflected light data (e.g., derived from the reflected first spectral portion and the reflected second spectral portion) to detect disturbance activity occurring in the untrusted area (e.g., intrusions in the untrusted area), disturbance activities occurring in the trusted areas (e.g., maintenance activities), or other activities.

Moreover, in the context of intrusion detection, existing light-based activity detection systems generally measure laser signal strength, Fresnel reflections, and Rayleigh backscatter either directly from the signal or from a reflected laser signal, which typically require numerous specialized and complex hardware (e.g., Fabry-Pérot (FP) lasers, precise pulse generators, etc.) that are costly or introduce other constraints (e.g., distributed acoustic sensing has limited dynamic range). To address such issues, in some embodiments, the remote termination units (e.g., respectively placed at two locations of the monitored fiber optic cable in the two trusted areas) may include a multi-mode fiber optic cable. As an example, as a laser signal travels through the multi-mode cable of each remote termination unit, the multi-mode cable causes dispersion of the laser signal, and much of this dispersed laser signal is reflected back from the multi-mode cable through the monitored cable. In one use case, an interrogator (e.g., fiber optic interrogator, a fiber optic controller, etc.) may detect the reflected laser. In this way, for example, due to the dispersion caused by the multi-mode cable, activity directed at or in a vicinity of the fiber optic cable causes a detectable change in the detected laser without necessarily requiring one or more specialized and complex hardware (e.g., without requiring the use of a distributed system of numerous Fiber Bragg grating (FBG) sensors, FP lasers, precise pulse generators, etc.).

Various other aspects, features, and advantages of the invention will be apparent through the detailed description of the invention and the drawings attached hereto. It is also to be understood that both the foregoing general description and the following detailed description are examples and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIG. 1 shows a system for facilitating activity detection via reflected light, in accordance with one or more embodiments.

FIGS. 2A-2B show arrangements of components of an interrogation system for facilitating activity detection, in accordance with one or more embodiments.

FIGS. 3A-3C show components of termination units, in accordance with one or more embodiments.

FIG. 4A shows an example signal of reflected light over a wavelength range before disturbance, in accordance with one or more embodiments.

FIGS. 4B-4C show example signals of reflected light over a wavelength range after disturbance at different areas, in accordance with one or more embodiments.

FIGS. 5A-5D show additional arrangements of components of an interrogation system for facilitating activity detection, in accordance with one or more embodiments.

FIG. 6A shows an example light signal reflected by a multi-mode cable of a remote termination unit and across a single-mode fiber optic cable captured by an interrogator when there was no movement of these components, in accordance with one or more embodiments.

FIG. 6B shows a portion of the example signal shown in FIG. 6A by zooming in, in accordance with one or more embodiments.

FIG. 6C shows a portion of an example signal similar to that shown in FIG. 6B but captured when there was a movement related to these components, in accordance with one or more embodiments.

FIG. 6D shows an overlay of the signals shown in FIGS. 6B and 6C, in accordance with one or more embodiments.

FIG. 7 shows example signals of reflected light over a wavelength range before disturbance and after disturbance, in accordance with one or more embodiments.

FIGS. 8A and 8B show example signals from an original reading and after scaling, respectively, in accordance with one or more embodiments.

FIG. 9 shows a machine learning model configured to facilitate activity detection, in accordance with one or more embodiments.

FIG. 10 shows a flowchart of a method of facilitating activity detection, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

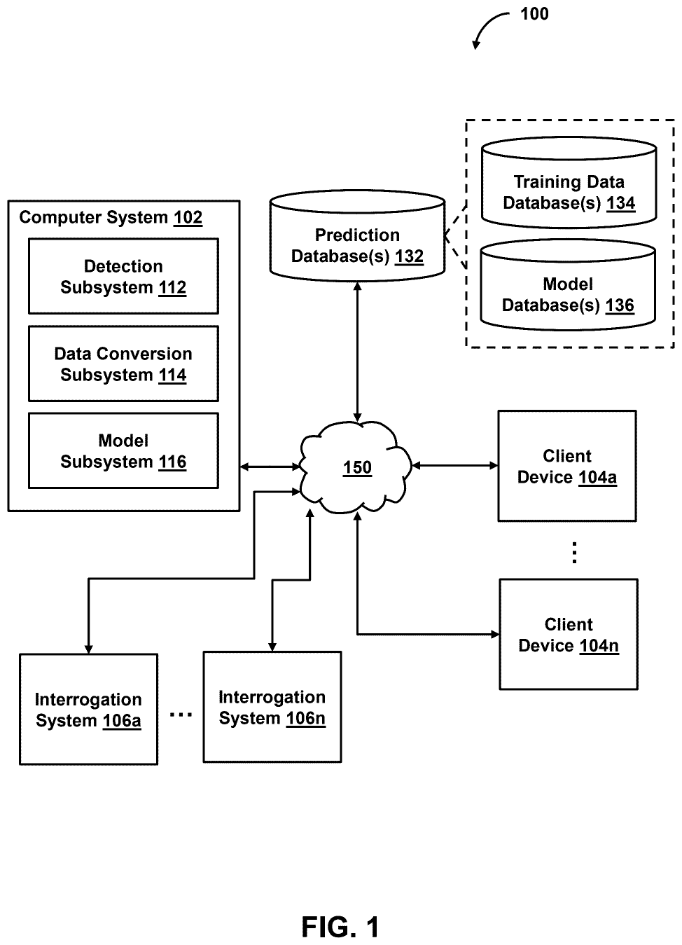

FIG. 1 shows a system 100 for facilitating activity detection via reflected light, in accordance with one or more embodiments. As shown in FIG. 1, system 100 may include computer system 102, client device 104 (or client devices 104a-104n), interrogation systems 106 (or interrogation systems 106a-106n), or other components. Computer system 102 may include detection subsystem 112, data conversion subsystem 114, model subsystem 116, or other components. Each client device 104 may include any type of mobile terminal, fixed terminal, or other device. By way of example, client device 104 may include a desktop computer, a notebook computer, a tablet computer, a smartphone, a wearable device, or other client device. Users may, for instance, utilize one or more client devices 104 to interact with one another, one or more servers, or other components of system 100. It should be noted that, while one or more operations are described herein as being performed by particular components of computer system 102, those operations may, in some embodiments, be performed by other components of computer system 102 or other components of system 100. As an example, while one or more operations are described herein as being performed by components of computer system 102, those operations may, in some embodiments, be performed by components of client device 104. It should be noted that, although some embodiments are described herein with respect to machine learning models, other prediction models (e.g., statistical models or other analytics models) may be used in lieu of or in addition to machine learning models in other embodiments (e.g., a statistical model replacing a machine learning model and a non-statistical model replacing a non-machine-learning model in one or more embodiments).

As indicated, where a physical transmission line spans across multiple areas, it is important to ascertain which area a detected activity occurred. As an example, in an environment where a monitored fiber optic cable spans between two trusted areas, the ability to determine whether human interaction or other activity occurred in trusted areas vs. untrusted areas is highly desirable.

For example, standard network maintenance activities in trusted areas often resemble cable intrusions, leading to a significant number of false alarms with non-location-specific detectors. Although pre-existing systems use fiber optic cables in trusted areas that are “desensitized” or less responsive to human interaction, these cables typically utilize interlocking metal armor or rigid materials. Many segments of cable often cannot utilize rigid materials (e.g., because of the need to be able to fully extend the cable at particular locations or other reasons). In addition, while a more sophisticated and costly detector or the introduction of sensors at specific locations of the cable may be utilized to implement location-specific detection, the former is often cost-prohibitive, and the latter is usually not feasible for cable that is already installed within an infrastructure (e.g., because incorporating sensors into cables is generally performed during the manufacturing process).

To address one or more of the foregoing issues, in some embodiments, system 100 may cause transmission of light into a physical transmission line, where the transmission line includes (i) a first cable portion in a first area, (ii) a second cable portion in a second area, (iii) a third cable portion between the first cable portion and the second cable portion and in a third area, and (iv) one or more other cable portions (e.g., in the first, second, or third area, one or more areas between the first and second area, or one or more other areas). System 100 may then detect an activity (e.g., related to the first, second, or third area) based on reflected light data. As an example, the reflected light data may be derived from a first light portion of the reflected light and a second light portion of the reflected light, where the first light portion is reflected back by a first termination unit in the first area (e.g., a remote termination unit in the first area), and the second light portion is reflected back by a second termination unit in the second area (e.g., a remote termination unit in the second area).

In one use case, the first area may be a secure or trusted location (e.g., a server room, a control center, etc.). The second area may also be a secure location (e.g., another server room, a different control center, any other location where the integrity of the transmission line is considered secure, etc.). The third area may be an untrusted or potentially vulnerable location where the security of the transmission line may not be as secure as the two trusted areas. As an example, the third area may be a public area, a stretch of cable that runs outside a secure building, or other location where there is a greater risk of the transmission line being tampered or accessed in an unauthorized manner, as compared to the two trusted areas. In some use cases, in addition to the three cable portions, the transmission line may also include one or more other cable portions located in other areas. The other areas may be additional trusted areas, untrusted areas, or areas with varying levels of security or vulnerability. In a further use case, the first termination unit in the first trusted area may be configured to reflect back a first spectral portion of the light and allow a second spectral portion of the light to pass through the first termination unit to one or more cable portions located in the untrusted area, and (ii) the second termination unit in the second trusted area may be configured to reflect back the second spectral portion of the light. Based on the foregoing arrangement, system 100 may use the reflected light data to detect disturbance activity occurring in the untrusted area (e.g., intrusions in the untrusted area), disturbance activities occurring in the trusted areas (e.g., maintenance activities), or other activities.

In some embodiments, the first and second termination units (or other termination units of system 100) may be or act as reflectors (or include one or more reflectors), such as selective reflectors (e.g., reflective filters), mirrors (e.g., non-selective reflectors), or other reflectors. In some embodiments, each of the termination units may include one or more splitters (e.g., couplers or other splitters), sensors, reflective filters, coiled cables (e.g., coiled single-mode or multi-mode cables), cable connector (e.g., angled physical contact (APC) connector or other connector), or other components. The splitter may allow a portion of the light to pass through the termination unit to the third cable portion, while the sensor and coiled cable may reflect respective parts of the light back towards the light source. In some embodiments, one or both ends of the coiled cables may be polished. In some embodiments, one or more of the sensors of the termination units may be replaced with or used as a reflective filter. In some embodiments, one or more of the coiled cables of the termination units may be replaced with or used as a distortion mirror. In some embodiments, the coiled cables of the termination units may be multi-mode cables (e.g., that has two or more coils, six or more coils, etc.). While multi-mode cables are not designed to be used as a reflector because multi-mode cables cause optical signals to become dispersed as they travel along the cable (e.g., which may cause signal distortion and loss of signal quality), the seemingly “negative” effects of the signal dispersion (e.g., signal distortion, loss of signal quality, etc.) also cause any changes to or around the vicinity of the monitored cable or its connected components to become more detectable by components of system 100.

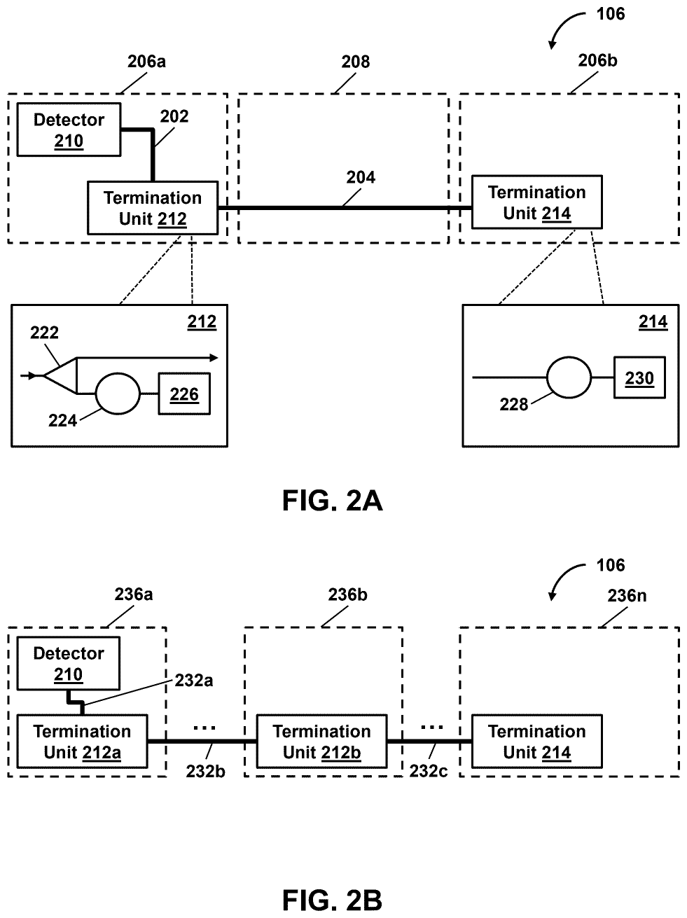

In one use case, with respect to FIG. 2A, interrogation system 106 may include a detector 210 (e.g., an optical interrogator or other detector) and a transmission line that includes a cable portion 202 in a first area 206a, a termination unit 212 in the first area 206a, a cable portion 204 through a third area 208, and termination unit 214 in a second area 206b. The first area 206a may be a secure server room or other trusted area. The second area 206b may be another trusted area, such as a different secure server room or control center. The third area 208 may be an untrusted public area, where the cable might be exposed to tampering or unauthorized access. As an example, termination unit 212 may include a coupler 222, a sensor 224, and a coiled cable 226. The coupler 222 may be configured to allow a first spectral portion to pass through to the sensor 224, while allowing a second spectral portion of the light to pass through to the next cable portion. In some use cases, the sensor 224 receives the first spectral portion from the coupler 222 and reflects part of the first spectral portion back, while the coiled cable 226 (e.g., a coiled multi-mode cable or other coiled cable) receives and reflects the light passing through the sensor 224, causing dispersion that makes any changes to the light more detectable. As another example, termination unit 214 may include a sensor 228 and a coiled cable 230. In some use cases, the sensor 228 receives the second spectral portion from the coupler 222 and reflects part of the second spectral portion back, while the coiled cable 230 (e.g., a coiled multi-mode cable or other coiled cable) receives and reflects the light passing through the sensor 224, causing dispersion that makes any changes to the light more detectable. The coupler 222 of termination unit 212 receives and combines the reflected first and second spectral portions, and the detector 210 receives the combined spectral portions.

In a further use case, in operation, a light source within detector 210 emits light into the transmission line, starting with cable portion 202 in the first area 206a. At termination unit 212 in the first area 206a, the coupler 222 allows the second spectral portion of the light to pass through to cable portion 204 in the untrusted area 208, while the sensor 222 and the coiled cable 226 reflect the first spectral portion back towards the light source in detector 210. The light that passes via the coupler 222 through the termination unit 212 travels to cable portion 204 in the untrusted area and reaches termination unit 214 in the second trusted area 206b, where the sensor 228 and the coiled cable 230 reflect the second spectral portion back towards the detector 210. The detector 210 collects the reflected light data from both the first and second spectral portions. In some use cases, the reflected light data may be processed via a prediction model, which analyzes the reflected light data to detect disturbances in the untrusted area 208 and the trusted areas 206a and 206b. For example, the prediction model may identify anomalies indicating potential tampering or unauthorized access in the untrusted area 208, while distinguishing such disturbances from benign activities, such as maintenance, in the trusted areas 206a and 206b.

In some use cases, with respect to FIG. 2A, coupler 222 of termination unit 212 may have an operating wavelength range between 1400-1700 nm (e.g., 1480-1620 nm) and a coupling ratio of 50/50. In other use cases, with respect to FIG. 2B, couplers 222 of termination units 212 (e.g., termination units 212a, 212b, etc.) may have different coupling ratios (while having the same or different operating wavelength range). As an example, a coupler 222 of termination unit 212a may have a coupling ratio of 33/67, and a coupler 222 of termination unit 212b may have a coupling ratio of 50/50. Both the couplers 222 may have the same operating wavelength range between 1400-1700 nm (e.g., 1480-1620 nm). Alternatively, the coupler 222 of termination unit 212a may have a first operating wavelength range between 1400-1700 nm (e.g., 1480-1620 nm), and the coupler 222 of termination unit 212b may have a second operating wavelength range narrower than the first operating wavelength range (e.g., less than 80% of the first operating wavelength range, less than 75% of the first operating wavelength range, less than 70% of the first operating wavelength range, etc.), which may improve return signal quality from the respective sensors and coiled cables of the termination units.), which may improve return signal quality from the respective sensors and coiled cables of the termination units in some scenarios.

In some scenarios, with respect to FIG. 2A, the termination units 212 and 214 may be separated by over three meters of cable, over ten meters of cable, over fifty meters of cable, over one hundred meters of cable, over two hundred meters of cable, over three hundred meters of cable, over a kilometer of cable, over five kilometers of cable, over ten kilometers of cable, over twenty kilometers of cable, over fifty kilometers of cable, a length of cable between two or more of the foregoing lengths (e.g., a length of cable between one hundred to three hundred meters, a length of cable between five to fifty kilometers, etc.), or other length of cable. In some scenarios, with respect to FIG. 2B, each subsequent pair of termination units 212 and 214 (e.g., termination units 212a and 212b, termination unit 212b and the next termination unit along cable 232, or other subsequent pair) may be separated by over three meters of cable, and one or more of the pairs may respectively be separated by a different length of cable (e.g., over ten meters of cable, over fifty meters of cable, over one hundred meters of cable, over two hundred meters of cable, over three hundred meters of cable, over a kilometer of cable, over five kilometers of cable, over ten kilometers of cable, over twenty kilometers of cable, over fifty kilometers of cable, etc.). In some scenarios, one or more of the pairs may be separated by a length of cable between one hundred to three hundred meters, a length of cable between five to fifty kilometers, or other length of cable. As discussed, many existing light-based activity detection systems perform activity detection by monitoring electrical signals from components such as photodiodes (e.g., the detector component) to measure the intensity of a light source (e.g., a laser source) and output an electronic signal related to the measurement. In the context of intrusion detection, such existing systems will typically measure laser signal strength, Fresnel reflections, and Rayleigh backscatter either directly from the signal or from reflected laser signal. Such existing systems, however, typically require numerous specialized and complex hardware (e.g., FBG sensors, FP lasers, precise pulse generators, etc.) to do so that are costly or introduce other constraints (e.g., distributed acoustic sensing has limited dynamic range). For example, an FBG sensor may typically respond to a change in strain or movement. However, the “range” within which an FBG sensor may detect movement or strain is limited to several feet surrounding the sensor (e.g., 3 meters or less on either side of the FBG), thereby requiring as many as thirty or more FBG sensors on a typical monitored cable for such existing systems. To the extent that a given termination unit 212 or 214 incorporates one or more of such hardware (e.g., an FBG sensor), the foregoing scenarios would not require the FBG sensor itself (or other specialized/complex hardware within the termination unit) to accurately detect movement or strain, and, thus, would not be limited by the range of such components. For example, in some embodiments, data from such sensors may be used as reference points to facilitate one or more operations described herein (e.g., to ensure a termination unit is connected to the unit by enabling the generation of a predictable wavelength peak, to create a predictable portion of the spectrum to be detected by one or more models to segregate the respective areas, etc.).

In some embodiments, one or more connectors may be arranged in a termination unit between a sensor of the termination unit and one end of a coiled cable of the termination unit (e.g., as opposed to fusing a fiber segment of the sensor to the coiled cable). Such connectors may include connectorized fiber with an angled physical contact (APC), a coupler (e.g., 1×1 coupler), or other connectors. Some embodiments may include such additional connectors to help facilitate or enhance the spectrum effect described herein to improve activity detection (e.g., by increasing the impact of the coiled cable, including where the coiled cable is a multi-mode cable segment). In some embodiments, one or more connectors may be arranged in the termination unit at the other end of the coiled cable of the termination unit (e.g., as opposed to the coiled cable having an unterminated end, to increase reflections of light that travels to the coiled cable). In other embodiments, such additional connectors may not be necessary, such as where the coiled cable is configured to reflect back a sufficient amount of the light traveling to the coiled cable.

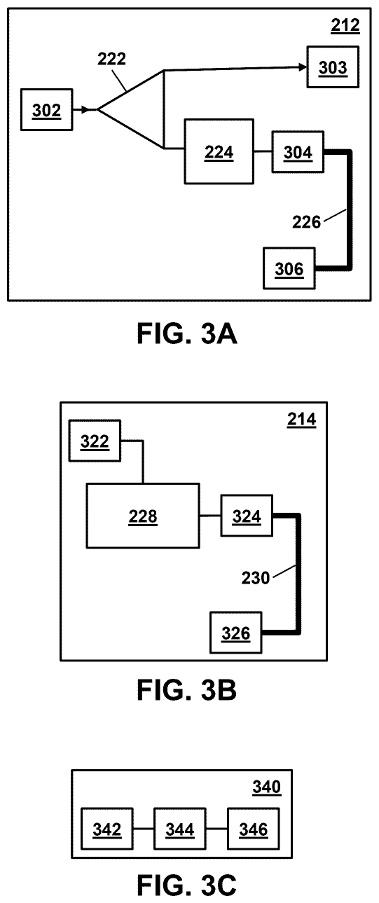

In one scenario, with respect to FIG. 3A, in addition to connectors 302 and 303 for receiving and transmitting a signal or portions thereof (or reflecting the signal or portions thereof), termination unit 212 may include (i) a connecting unit 304 of one or more connectors between the sensor 224 and the coiled cable 226 and (ii) a connecting unit of one or more connectors at the other end of the coiled cable 226. In another scenario, with respect to FIG. 3B, in addition to a connector 322 for receiving and transmitting a signal or portions thereof (or reflecting the signal or portions thereof), termination unit 214 may include (i) a connecting unit 324 of one or more connectors between the sensor 228 and the coiled cable 230 and (ii) a connecting unit 326 of one or more connectors at the other end of the coiled cable 230. As another example, each of the connecting units 304, 306, 324, and 326 may include a single connector, such as a single connectorized fiber. As another example, with respect to FIGS. 3A-C, each of the connecting units 304 and 324 may correspond to a connecting unit 340, and, thus, may include connectors 342, 344, and 346 (e.g., connected to one another via single-mode fiber segments), such as one or more connectorized fibers, 1×1 couplers, or other connectors. In one use case, connector 342 may be a connectorized fiber, connector 344 may be a 1×1 coupler, and connector 346 may be another connectorized fiber. As another example, each of the connecting units 306 and 326 may correspond to the connecting unit 340 and, thus, may include connectors 342, 344, and 346, such as one or more connectorized fibers, 1×1 couplers, or other connectors.

In some embodiments, spectrum data captured by an interrogator may include a multi-dimensional array of data based on the wavelength range being monitored, thereby taking a large amount of memory or storage. To address such issues, in some embodiments, system 100 may perform activity detection by monitoring selected portions of a wavelength range of the reflected light, instead of the entire wavelength range, using techniques, such as those described in U.S. application Ser. No. 18/364,454, filed Aug. 2, 2023, and entitled “Activity Detection in Fiber Optic Network,” the content of which are incorporated herein by reference in its entirety. As an example, during a calibration phase, calibration intensity peaks may be detected at different wavelengths of a wavelength range reflected by the multi-mode fiber optic cable of the termination unit and across the single-mode fiber optic cable. Based on the calibration intensity peaks, reference positions for sampling windows of the wavelength range may be determined. As an example, for each of the sampling windows, the reference positions may include a starting point (e.g., a starting wavelength) and an endpoint (e.g., an end wavelength) of the sampling window. Each of the sampling windows may include a corresponding wavelength of an intensity peak of the calibration intensity peaks. The sampling windows collectively may omit other wavelengths of the wavelength range between respective ones of the sampling windows of the wavelength range. Subsequently, light reflected across the fiber optic cable during an operation phase may be monitored based on the reference positions for the sampling windows, while omitting the other wavelengths of the wavelength range, thereby reducing computation resource usage or processing time (and, thus, increasing the efficiency of the system). Based on the monitoring, one or more activities related to the fiber optic cable may be detected via one or more machine learning models or other prediction models.

In some embodiments, the activity detection may be performed based on a combination of multiple outputs respectively reflected from multiple termination units along a physical transmission line. As an example, with respect to FIG. 2A, the detector 210 captures combined spectrum data resulting from an overlapping of the reflected light reflected from the termination unit 212 in the area 206a and the reflected light reflected from the termination unit 214 in the area 206b, and system 100 may perform activity detection based on the combined spectrum data. As another example, with respect to FIG. 2B, the detector 210 captures combined spectrum data resulting from an overlapping of the reflected light reflected from the termination unit 212a in the area 236a, the termination unit 212b in the area 236b, and the termination unit 214 in the area 236n (e.g., and other termination units in other areas between area 236b and 236n), and system 100 may perform activity detection based on the combined spectrum data.

As a further example, with respect to FIGS. 2A and 3, the spectrum segment S2 of FIG. 3 is a result of the outputs from the respective sensors 224 and 228 of the termination units 212 and 214 overlapping. In one use case, the sensors 224 and 228 may be chirp” FBGs, which produce the spectrum effect shown in the spectrum segment S2 of FIG. 3, which enables system 100 to more easily deduce the detected activity area. Unlike standard FBGs, which reflect a very narrow portion of the spectrum, chirp FBGs reflect across a wide range of spectrum, thereby creating a noticeably higher signal effect.

In some embodiments, system 100 may filter reflected light data based on sensor-reflected wavelengths (e.g., respectively corresponding to broadband reflections of sensors of one or more termination units), coiled-cable-reflected wavelengths (e.g., respectively corresponding to reflections of coiled cables of the termination units), or other wavelengths. In some embodiments, system 100 may filter reflected light data based on one or more chirp spectrums generated by one or more termination units and perform activity detection based on the filtered reflected light data. As an example, each of the termination units may include a chirp FBG sensor configured to reflect a broad range of wavelengths. As an example, the termination units may include a first termination unit that includes a first chirp FBG sensor configured to reflect a first wavelength range, a second termination unit that includes a second chirp FBG sensor configured to reflect a second wavelength range different from the first wavelength range, etc. As another example, the termination units may further include one or more other termination units that are configured to reflect one or more other ranges of wavelengths different from the first and second ranges of wavelengths. System 100 may filter the reflected light data based on one or more of the foregoing ranges of wavelengths that the respective chirp FBG sensors are configured to reflect (e.g., such that the filtered reflected light data excludes one or more of the foregoing ranges of wavelengths). System 100 may then detect, via a prediction model, a disturbance activity related to an untrusted area based on the filtered reflected light data.

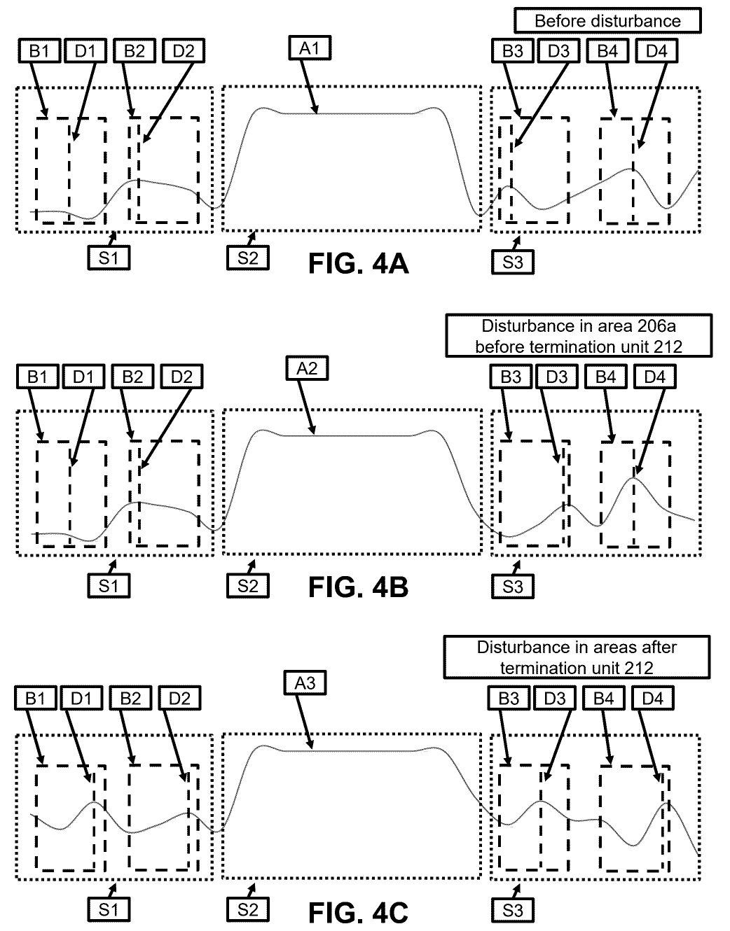

In one scenario, with respect to FIGS. 4A-4C, system 100 may filter out the spectrum segment S2 from the respective signals A1, A2, and A3 and use the spectrum segments S1 and S3 of the respective signals A1, A2, and A3 to perform the activity detection (e.g., where the x-axis represents the wavelengths, and the y-axis represents power). The spectrum segment S2 may correspond to the reflected spectrums from the respective sensors 224 and 228 of the termination units 212 and 214 (e.g., of FIG. 2A) overlapping. In another scenario, the segment S1 may correspond to the reflected spectrum from the coiled cable 226 of the termination unit 212, and the segment S3 may correspond to the reflected spectrum from the coiled cable 230 of the termination unit 214 (e.g., of FIG. 2A). As an example, system 100 may input a representation of the spectrum segments S1 and S3 as an input to the prediction model to generate an inference. As another example, system 100 may input respective representations of the spectrum segments S1 and S3 as separate inputs corresponding to different input parameters (e.g., two different inputs corresponding to two different input parameters), thereby enabling the prediction model to distinguish the respective signal portions as corresponding to the input parameters.

In some embodiments, with respect to a reference wavelength range (e.g., associated with one or more sensors of termination units), system 100 may detect a disturbance based on a determination that two or more wavelength ranges of reflected light data satisfy one or more change thresholds. In some embodiments, system 100 may detect a disturbance based on each of first and second wavelength ranges of the reflected light data satisfying the change threshold. As an example, the first and second wavelength ranges (e.g., respective ranges within two separate sampling windows) may both be shorter than a shortest wavelength of the reference wavelength range. As another example, the first and second wavelength ranges (e.g., respective ranges within two separate sampling windows) may both be longer than a longest wavelength of the reference wavelength range. As a further example, the first wavelength range may be shorter than the shortest wavelength of the reference wavelength range, and the second wavelength range may be longer than the longest wavelength of the reference wavelength range.

As an example, FIG. 3 shows an example spectrum reflected by the termination units on a physical transmission line (e.g., termination units 212 and 214 of FIG. 2A) before any disturbance occurs. In one use case, when utilizing sensor segmentation, only the “non-chirp” spectrum segments S1 and S3 are analyzed (where the “chirped” spectrum shown in the spectrum segment S2 may be used as a reference wavelength range). The “chirped” spectrum may be derived by detecting the extra wide peak of the chirp FBG sensors or based on known spectrum ranges established during the manufacture of the sensors of the termination units. System 100 may track the boundaries and peaks of the spectrum on the spectrum segments S1 and S3 separately. As an example, the spectrum segment S1 (the section of spectrum that precedes the chirped spectrum) may represent an area of spectrum that is least impacted by activity resulting in changes to the cable's state at locations before the location of a first termination unit (e.g., termination unit 212). On the other hand, the spectrum segment S3 (the section of spectrum that follows the chirped spectrum) may represent an area of spectrum that is most impacted by activity resulting in changes to the cable's state at locations before the location of the first termination unit.

In some use cases, the behavior of these two segments allows the system 100 to determine whether activity is occurring before or after the first termination unit. As an example, FIG. 3B shows disturbance to a cable that occurs before the location of the first termination unit, where the boundaries monitored by one or more models of system 100 will show the largest amount of change to the peaks and spectrum in that area (e.g., see changes between signals A1 and A2 of FIGS. 4A and 4B in segment S3). However, when the cable is manipulated after the first termination unit, significant change may be observed in both segments S1 and S3 (e.g., see changes between signals A1 and A3 of FIGS. 4A and 4C in segments S1 and S3). By monitoring the degree of change in both areas, the system 100 may derive which area of the cable was manipulated.

It should be noted that, in some embodiments, the chirp spectrums (or other spectrums to be filtered out or otherwise excluded from model inputs before inputting them into a model for inference or other determinations) may not necessarily have peaks as uniformly flat as shown in FIGS. 4A-4C. In some embodiments, the wide peak reflected from one sensor (e.g., a second chirp FBG) may not be as uniformly flat as the wide peak reflected from another sensor (e.g., a first chirp FBG). Nevertheless, in either case, the distinctive width of each peak of the sensors, such as those from chirp FBGs, enables easier identification of each sensor's location in the spectrum.

As discussed, spectral features of reflected light may depend on or relate to characteristics of components in a light path that the light traverses (e.g., the core size, material, or length of the multi-mode fiber optic cable of the termination unit), a specific fiber optic cable to be monitored, a specific fiber interrogator, or other components. A specific combination of these components configured for monitoring a fiber optic cable may correspond to a specific combination of spectral features of the reflected light. However, in some embodiments, instead of a dedicated prediction model for each combination of these components of a monitoring system, a light signal reflected by a termination unit and detected by a fiber interrogator may be processed such that the processed signal may be analyzed using a common prediction model (e.g., by scaling or performing other normalization techniques on the reflected light signal), thereby increasing the versatility of the prediction model of the system.

In some embodiments, based on the activity detection, system 100 may perform one or more actions related to a physical transmission line. In some embodiments, system 100 may cause shutdown of network dataflow to one or more network endpoints based on the activity detection. As an example, in response to a detected disturbance on the physical information transmission line, system 100 may initiate shutdown of the network data flow to the network endpoints proximate to the detected disturbance. In one scenario, the initiation of the shutdown of the network data flow may include transmitting a port disabling command to a data flow control switch to disable a port associated with the network endpoints, rerouting at least a portion of the network data flow to avoid the network endpoints, or other actions. In some embodiments, system 100 may generate one or more alarms or other notifications based on the activity detection.

### Subsystems 112-116

In some embodiments, detection subsystem 112 may analyze a light signal. The light may be captured by a sensor. As an example, the captured light may be light that is reflected by a termination unit (e.g., remote termination unit) and across a fiber optic cable or other light carrier or emitter (e.g., used as part of a physical transmission line or other system).

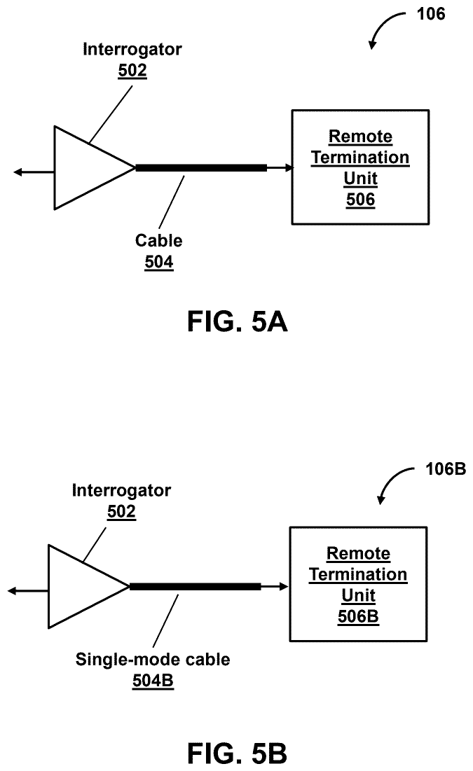

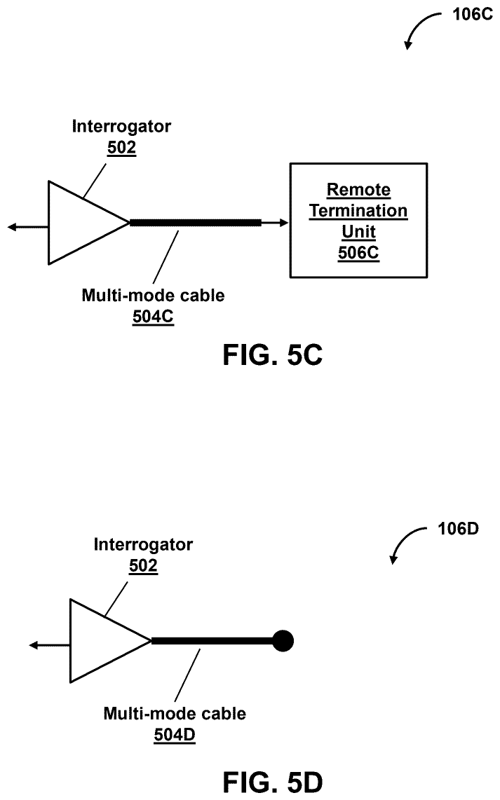

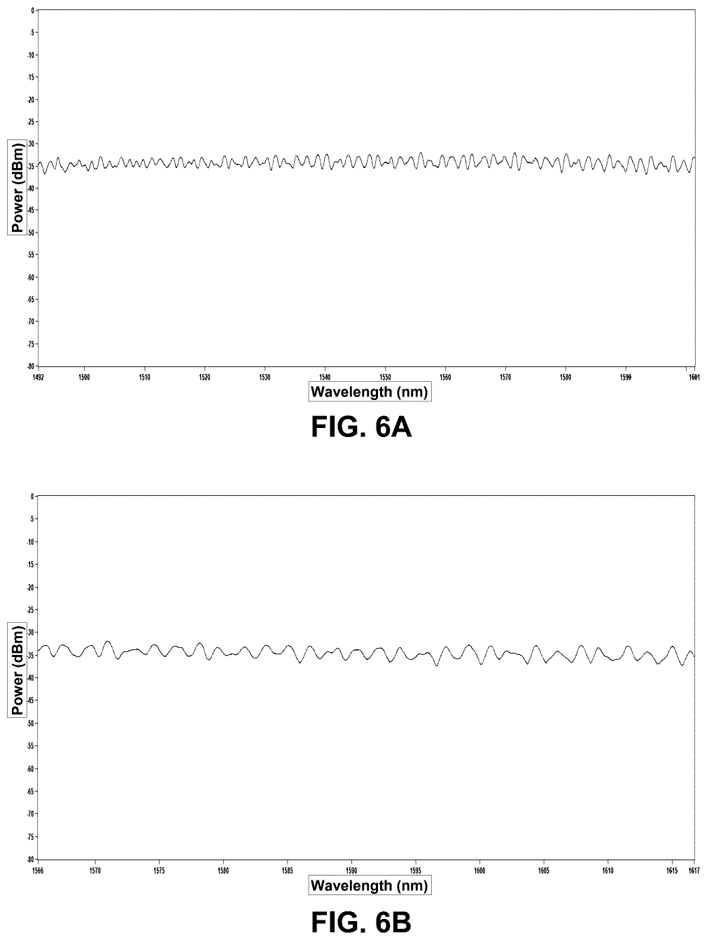

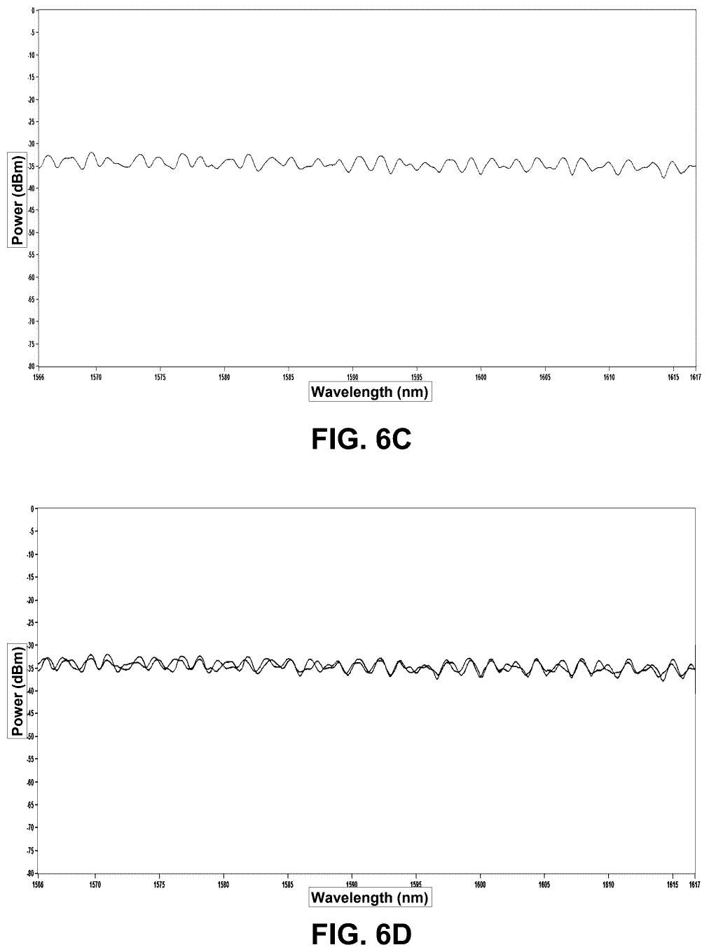

As illustrated in FIG. 5A, interrogation system 106 may include interrogator 502, cable 504, and remote termination unit 506. Interrogator 502 may be configured to detect light signals. As an example, interrogator 502 may detect a light signal from cable 504 and output data (e.g., spectral data representing a relationship between signal amplitudes and wavelengths at different times or other data) to one or more processing units (e.g., one or more processing units in detection subsystem 112, one or more processing units in data conversion subsystem 114, etc.). The detected data may be presented in the form illustrated in FIGS. 6A-6D, in which the horizontal axis is the wavelengths of a detected light signal (in nanometers (nm)), and the vertical axis is the power or amplitude of the detected light signal (in decibel-milliwatts (dBm)). As illustrated, the effect of the remote termination unit on a reflected light signal may be random or based on one or more parameters (e.g., the length of the multi-mode fiber in the remote termination unit, other intrinsic or extrinsic parameters of the cable in the remote termination unit, the overall state of the fiber optic cable to be monitored, etc.), as discussed elsewhere herein).

FIG. 6A shows an example light signal reflected by a multi-mode cable of a remote termination unit detected by an example interrogator when there was no movement of these components, in accordance with one or more embodiments. The wavelength range of the detected light signal illustrated in FIG. 6A is between 1492 nanometers and 1601 nanometers. The wavelength range of the light reflected by the remote termination unit may (substantially) coincide with or exceed the wavelength range of the detected light signal shown in FIG. 6A. FIG. 6B shows a portion of the example signal in FIG. 6A by zooming in on the example signal. The wavelength range of the detected light signal illustrated in FIG. 6B is between 1566 nanometers and 1617 nanometers. FIG. 6C shows a portion of an example signal similar to that shown in FIG. 6B but captured when there was a movement related to at least one of these components, in accordance with one or more embodiments. FIG. 6D shows an overlay of the signals shown in FIGS. 6B and 6C, showing that a movement related to at least one of these components may cause a detectable change in the light signal.

In some embodiments, interrogator 502 may be configured to emit a light signal across cable 504 dedicated for monitoring purposes. In some embodiments, no dedicated light signal is employed, and monitoring may be performed based on light signals configured to transmit data.

Cable 504 may be single-mode (e.g., cable 504B as illustrated in FIG. 5B) or multi-mode (e.g., cable 504C as illustrated in FIG. 5C, or cable 504D as illustrated in FIG. 5D). In some embodiments, cable 504 may be configured to transmit data and also transmit light signals for monitoring purposes. In some embodiments, cable 504 may be a dedicated cable for transmitting light for monitoring purposes. Cable 504 may be operably connected to interrogator 502 such that cable 504 may receive and transmit light from interrogator 502 or transmit light to interrogator 502. For example, at least a portion of light reflected across cable 504 may impinge upon and be detected by interrogator 502.

As an example, with respect to interrogation system 106B illustrated in FIG. 5B, the cable in remote termination unit 506B may be a multi-mode cable, while cable 504B may be a single-mode cable. A single-mode cable is configured to propagate a single light mode, whereas a multi-mode cable is configured to allow propagation of multiple simultaneous light modes. Compared to a multi-mode cable, a single-mode cable usually has a smaller core diameter, a lower bandwidth, and less light dispersion. Due to these and other differences, coupling of a single-mode cable with a multi-mode cable may cause signal distortion and loss, undesirable in data transmission. However, as illustrated in the present disclosure, when a multi-mode cable is passively coupled to a single-mode cable (e.g., at an end of the single-mode cable) the change in the core size may create an environment where light coming from the single-mode cable is reflected at a variety of wavelengths in the multi-mode cable.

Light reflection in the multi-mode cable may depend on or relate to intrinsic parameters (e.g., the core size, the material, the length of the multi-mode cable, etc.) or extrinsic parameters (e.g., the diameter of a coil, number of coils, etc.), curvature of a portion of the cable), relative positions of various portions of the coils of the multi-mode cable, etc.). While an intrinsic parameter may be set for a multi-mode cable, an extrinsic parameter may change by an activity directed to or in the vicinity of the multi-mode cable.

The reflected light from the multi-mode cable may further enter the single-mode cable (e.g., to which the multi-mode cable is passively coupled) and be reflected across the single-mode cable so as to be detected by one or more sensors (e.g., interrogator 502) operably coupled to the single-mode cable. Similar to a multi-mode cable, light reflection in the single-mode cable may depend on or relate to intrinsic or extrinsic parameters of the single-mode cable. Also similar to a multi-mode cable, while an intrinsic parameter may be set for a single-mode cable, an extrinsic parameter may change by an activity related to (e.g., directed to or in a vicinity of) the single-mode cable. Accordingly, light reflected by the multi-mode cable in remote termination unit 506B and across cable 504B may carry information regarding intrinsic parameters and extrinsic parameters of the multi-mode and single-mode cables.

By teasing out information associated with intrinsic parameters of the multi-mode cable and of the single-mode cables, information associated with extrinsic parameters (e.g., one or more activities related to the multi-mode cable or the single-mode cables) may be detected based on the reflected light. As an example, reflected light detected in a calibration phase may be used to represent a baseline or reference state of cable 504B, while a change in the reflected light detected in an operation phase (e.g., a change relative to or determined based on the reflected light detected in the calibration phase) may indicate one or more activities related to cable 504B (e.g., FIGS. 6A-6D and relevant description thereof).

FIG. 5C shows another example of interrogation system 106C including a multi-mode cable 504C to be monitored. Interrogation system 106C may include interrogator 502 and remote termination unit 506C operably coupled to opposite ends of cable 504C. Remote termination unit 506C may include at least one FBG sensor (e.g., a single FBG sensor) configured to provide a reference reflected light. Multi-mode cable 504C may generate reflected light (e.g., with minimal length). Interrogator 502 may detect both the reference reflected light generated by remote termination unit 506C and the light reflected across cable 504C, thereby facilitating the detection of an activity (e.g., a cut or damage) related to cable 504C. On the other hand, as illustrated in FIG. 5D, without a remote termination unit (e.g., remote termination unit 506C) operably coupled to an end of multi-mode cable 504D (similar to multi-mode cable 504C), system 100 may be unable to accurately detect an activity (e.g., a cut or damage) related to cable 504D based on light reflection that occurs in cable 504D with minimal length along cable 504D (e.g., due to a lack of a reference reflected light).

Remote termination unit 506 may be operably coupled to cable 504 via a connector. The connector may be an angled physical contact (APC) connector, or an ultra physical contact (UPC) connector. As an example with respect to FIG. 5B, remote termination unit 506B includes a multi-mode cable that is passively coupled to single-mode cable 504B via an APC connector such that the angled polishing of the APC connector may reduce the amount of the reflected light generated in the multi-mode cable to return to the multi-mode cable, and accordingly allow more of the reflected light to re-enter cable 504B and ultimately be detected by interrogator 502.

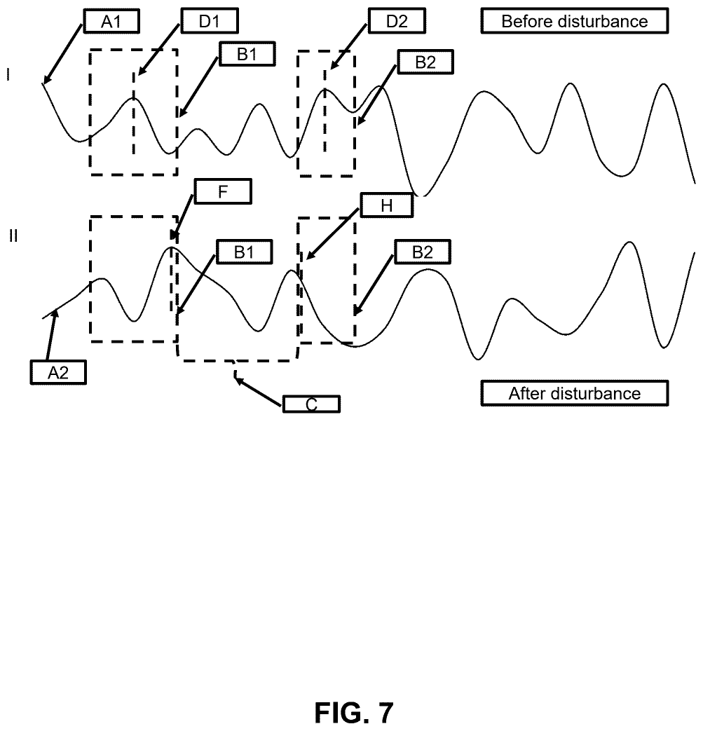

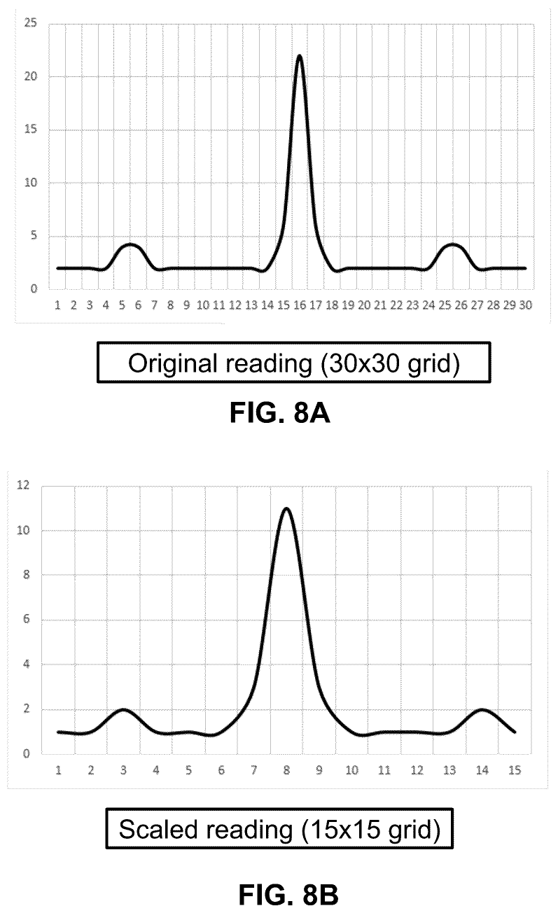

Referring back to FIG. 1, detection subsystem 112 may process sensor data captured during a calibration phase. As an example, the sensor data may include a wavelength range reflected by the coils of the multi-mode fiber optic cable of the remote termination unit and then reflected across the single-mode fiber optic cable during the calibration phase. Detection subsystem 112 may detect calibration intensity peaks at different wavelengths of the wavelength range. As an example, detection subsystem 112 may detect calibration intensity peaks using a threshold-based detection algorithm, by detecting local maxima that have higher intensity values than their neighbors, or via other techniques (e.g., see panel I of FIG. 7 illustrating dotted line D1 that indicates a calibration intensity peak and its corresponding wavelength in sampling window B1, and dotted line D2 that indicates a calibration intensity peak and its corresponding wavelength in sampling window B2). In some embodiments, detection subsystem 112 may pre-process the sensor data before applying the peak detection algorithm. As an example, detection subsystem 112 may pre-process the sensor data using one or more of various techniques including, for example smoothing filters (e.g., Gaussian or Savitzky-Golay) and a baseline correction algorithm.

In some embodiments, detection subsystem 112 may determine, based on the calibration intensity peaks, reference positions for sampling windows of the wavelength range so that only a portion of the wavelength range is analyzed further, thereby reducing computation resource usage (e.g., storage resource, computing resource, etc.) and processing time (and, thus, increasing the efficiency of the system). In some embodiments, the reference positions for the sampling windows are determined such that (i) each window of the sampling windows includes a corresponding wavelength of an intensity peak of the calibration intensity peaks and (ii) the sampling windows collectively do not include other wavelengths of the wavelength range between respective ones of the sampling windows of the wavelength range. As an example, for a calibration intensity peak, detection subsystem 112 may identify its corresponding wavelength within the wavelength range. Detection subsystem 112 may then determine a sampling window enclosing the corresponding wavelength. For instance, detection subsystem 112 may determine the reference positions of the sampling window by positioning the corresponding wavelength (substantially) at a center of the sampling window. As an example, for each of the sampling windows, the reference positions may include a starting point (e.g., a starting wavelength) and an endpoint (e.g., an end wavelength) of the sampling window.

In some embodiments, detection subsystem 112 may identify two or more wavelength ranges and perform such sampling window determinations for each of the wavelength ranges. As an example, with respect to a reference wavelength range (e.g., associated with one or more sensors of termination units), detection subsystem 112 performs the sampling window determinations for a wavelength range shorter than a shortest wavelength of the reference wavelength range and for a wavelength range longer than a longest wavelength of the reference wavelength range. In one scenario, with respect to FIGS. 4A-4C, only the “non-chirp” spectrum segments S1 and S3 may be analyzed (where the “chirped” spectrum shown in the spectrum segment S2 may be used as a reference wavelength range). The “chirped” spectrum may be derived by detecting the extra wide peak of the chirp FBG sensors or based on known spectrum ranges established during the manufacture of the sensors of the termination units. System 100 may track the boundaries and peaks of the spectrum on the spectrum segments S1 and S3 separately. As an example, the spectrum segment S1 (e.g., a wavelength range where all its wavelengths are shorter than a shortest wavelength of the spectrum segment S2) may represent an area of spectrum that is least impacted by activity resulting in changes to the cable's state at locations before the location of a first termination unit (e.g., termination unit 212). On the other hand, the spectrum segment S3 (e.g., a wavelength range where all its wavelengths are longer than a longest wavelength of the spectrum segment S2) may represent an area of spectrum that is most impacted by activity resulting in changes to the cable's state at locations before the location of the first termination unit.

In some scenarios, with respect to FIG. 4A, the signal A1 may be used during calibration to determine characteristics of normal or authorized activities (e.g., to establish baseline data, to obtain training data used to train a machine learning model, etc.). As an example, with respect to the spectrum segment S1 of FIG. 4A, the dotted line D1 may indicate a calibration intensity peak and its corresponding wavelength in sampling window B1, and the dotted line D2 may indicate a calibration intensity peak and its corresponding wavelength in sampling window B2. With respect to the spectrum segment S3 of FIG. 4A, the dotted line D3 may indicate a calibration intensity peak and its corresponding wavelength in sampling window B3, and the dotted line D4 may indicate a calibration intensity peak and its corresponding wavelength in sampling window B4.

In some embodiments, detection subsystem 112 may select reference positions of a sampling window based on a wavelength range threshold, a waveform of the signal within the sampling window, a distance from a neighboring sampling window, or other criteria. In some embodiments, the wavelength range threshold of a sampling window may define a minimum range of the sampling window (e.g., 2 nm, 3 nm, 5 nm, 10 nm, etc.), a maximum range of the sampling window (e.g., 5 nm, 10 nm, 20 nm, etc.), or other criteria. Based on the wavelength range threshold, the reference positions corresponding to the starting point and the endpoint of the sampling window may be determined such that the calibration intensity peak may be positioned (substantially) at a center of the sampling window. As used herein, “substantially,” when it is used to qualify a feature, indicates that a deviation from the feature is below a threshold. As an example, “substantially,” when it is used here to qualify the feature “at a center of a sampling window,” indicates that a deviation of the wavelength corresponding to the calibration intensity peak in a sampling window from the center of the wavelengths enclosed in the sampling window is below a threshold (e.g., 20%, 10%, 5%, or other percentage of the width of the sampling window).

In some embodiments, detection subsystem 112 may determine reference positions of a sampling window based on the waveform of the signal within the sampling window. For example, detection subsystem 112 may determine reference positions of a sampling window such that on one side (e.g., the left side) of the sampling window (where the wavelengths are smaller than the wavelength corresponding to the calibration intensity peak of the sampling window), the amplitudes of the signal increase (substantially) monotonically (e.g., the portion of the signal to the left of the dotted line D1 in sampling window B1 and the portion of the signal to the left of the dotted line D2 in sampling window B2 in panel I of FIG. 7), while on the other side (e.g., the right side) of the sampling window (where the wavelengths are larger than the wavelength corresponding to the calibration intensity peak of the sampling window), the amplitudes of the signal decrease (substantially) monotonically (e.g., the portion of the signal to the right of the dotted line D1 in sampling window B1 and the portion of the signal to the right of the dotted line D2 in sampling window B2 in panel I of FIG. 7).

Additionally, or alternatively, detection subsystem 112 may determine reference positions of sampling windows based on a spacing threshold such that each sampling window of the sampling windows is separated by at least the spacing threshold from a next sampling window of the sampling windows closest to the sampling window. In one use case, a spacing threshold may be 4 nm, 6 nm, 10 nm, 20 nm, or another spacing amount. The spacing threshold may be user-defined, automatically derived from wavelength ranges of one or more prior sampling windows (e.g., 1×, 2×, 3×, or other multiple of the range of the immediately prior sampling window or of an average of two or more prior sampling windows, a multiple of an output derived from the range of the immediately prior sampling window or of an output derived from an average of two or more prior sampling windows, etc.).

As an example, for a first sampling window and a second sampling window next to each other where the starting position (wavelength) of the first sampling window is smaller than the starting position (wavelength) of the second sampling window, detection subsystem 112 may determine the distance between the two sampling windows based on a distance between an end position of the first sampling window (e.g., the maximum wavelength in the first sampling window) and a start position of its neighbor sampling window on the right (e.g., the minimum wavelength in the second sampling window) (see, e.g., spacing C between sampling windows B1 and B2 next to each other as illustrated in FIG. 7). As another example, for two sampling windows next to each other, detection subsystem 112 may determine the distance between the two sampling windows based on a distance between the wavelengths corresponding to the calibration intensity peaks in the respective sampling windows.

As a further example, for two sampling windows next to each other, detection subsystem 112 may determine the distance between the two sampling windows based on a distance between corresponding positions (e.g., start positions, end positions) of the sampling windows. Detection subsystem 112 may determine the reference positions of the two sampling windows next to each other such that the distance between the two sampling windows is no less than the spacing threshold. Detection subsystem 112 may determine the reference positions of the two sampling windows next to each other such that the two sampling windows do not overlap. In this way, the sampling windows collectively do not span the entire wavelength range reflected by remote termination unit 506 or the entire wavelength detectable by one or more sensors. In some embodiments, the spacing threshold may be set based on a user instruction. The spacing threshold may improve performance of system 100 by avoiding concentration of sampling windows over a narrow portion of the wavelength range and ensuring a sufficient portion of the wavelength range is sampled without increasing the number (count) of the sampling windows and without increasing the computation resource usage or processing time.

In some embodiments, at least two of the sampling windows may have different window widths. A different number of wavelengths may be sampled in a window than at least one other window of the sampling windows. As an example, a first sampling window may encompass wavelengths between 1500 nanometers and 1520 nanometers, in which 10 wavelengths may be sampled for every 2 nanometers; a second sampling window may encompass wavelengths between 1550 nanometers and 1550 nanometers, in which 15 wavelengths may be sampled for every 2 nanometers; accordingly, the first and second sampling windows may have different window widths (a window width of 20 nanometers for the first sampling window and a window width of 30 nanometers for the second sampling window), and a different number of wavelengths may be sampled in the first sampling window than the second sampling window.

In some embodiments, in the calibration phase, detection subsystem 112 may detect local intensity extrema (e.g., local intensity peaks, local intensity valleys) at different wavelengths of a wavelength range reflected across a first cable of a first mode (e.g., cable 504 as illustrated in FIG. 5A, single-mode cable 504B as illustrated in FIG. 5B, and multi-mode cable 504C as illustrated in FIG. 5C), in which the wavelength range is reflected by a second cable of a second mode. As an example, detection subsystem 112 may detect local intensity extrema using a threshold-based detection algorithm, by detecting local maxima that have higher intensity values than their neighbors, by detecting local minima that have higher intensity values than their neighbors, or via other techniques. In some embodiments, detection subsystem 112 may determine, based on the local intensity extrema, reference positions for sampling windows of the wavelength range such that (i) each window of the sampling windows may include a corresponding wavelength of a local extremum of the local intensity extrema and (ii) the sampling windows collectively do not include other wavelengths of the wavelength range between at least two of the sampling windows of the wavelength range. In some embodiments, a different number of wavelengths may be sampled in a sampling window than at least another window of the sampling windows.

Compared to existing technology in which one or more peaks or valleys are identified in a signal as individual reference points for detecting a change in the signal, detection subsystem 112 may identify calibration intensity peaks or extrema to further determine sampling windows, allowing monitoring over a broader range of the signal that falls within the sampling windows, while avoiding monitoring an entire wavelength range reflected by the remote termination unit or an entire wavelength range detected by the interrogator.

In some embodiments, system 100 may perform calibration automatically upon the start of monitoring. In some embodiments, as part of the calibration phase, system 100 may test detection capabilities. In some embodiments, after an initial calibration, system 100 may repeat calibration upon detection of a significant change to a fiber optic cable to be monitored or its surroundings, or according to a user request. In some embodiments, prior to calibration or other operations, system 100 may perform a quality assurance check or verification. In some embodiments, system 100 may check captured spectrum data for general inconsistencies or errors. For example, system 100 may check for incomplete spectrum signals lacking wavelength/power values for significant portions of the detected data. As another example, system 100 may check for incorrect spectrum data containing large amounts of positive power values at the start of the spectrum data when power values are typically expressed as a negative number. System 100 may proceed to calibration upon satisfactory quality assurance check or verification.

In some embodiments, detection subsystem 112 may store the reference positions of the sampling windows. Subsequent to storing the reference positions of the sampling windows, detection subsystem 112 may proceed to a detection phase (or referred to as an operation phase) and monitor cable 504 (e.g., cable 504B as illustrated in FIG. 5B, cable 504C as illustrated in FIG. 5C, etc.) based on the reference positions of the sampling windows, not the entire wavelength range reflected by remote termination unit 506 (e.g., remote termination unit 506B as illustrated in FIG. 5B, remote termination unit 506C as illustrated in FIG. 5C), and not the entire wavelength range detected by interrogator 502, thereby reducing computation resource usage or processing time. As an example, interrogator 502 may detect at least a portion of the light reflected across cable 504B, and filter, based on the reference positions for the sampling windows, the detected light to obtain filtered light data that excludes wavelengths outside of the sampling windows. As another example, interrogator 502 may detect at least a portion of the light reflected across cable 504B, and detection subsystem 112 may extract portions of the detected light, based on the reference positions for the sampling windows, to obtain filtered light data that excludes wavelengths outside of the sampling windows.

In some embodiments, detection subsystem 112 may obtain light detected by one or more sensors (e.g., reflected light detected by interrogator 502) and filter the detected light based on the reference positions for the sampling windows to obtain filtered light data that excludes wavelengths outside of the sampling windows. In one use case, the reference positions for a first sampling window may be starting and ending positions 1566 nm and 1568 nm, the reference position for a second sampling window may be starting and ending positions 1574 nm and 1577 nm, the reference position for a second sampling window may be starting and ending positions 1583 nm and 1585 nm, and so on. As such, where the spacing threshold is 6 nm, the filter light data may include wavelengths 1566-1568 nm, 1574-1577 nm, and 1583-1585 nm and their respective amplitudes, but excludes wavelengths 1569-1573 nm, 1578-1582 nm, and 1586-1550 nm.

In some embodiments, detection subsystem 112 may determine one or more activities related to cable 504 based on the filtered light data. In some embodiments, such activities may include one or more activities related to one or more cables to be monitored, such as a cable cut, human-perceivable movement, or non-oscillating movement and oscillating motion (e.g., vibrations). As an example, a cable cut may correspond to a significant signal loss (e.g., a significant decrease in the signal intensity or power level). In some use cases, a signal loss detected may be due to a cable cut or another event (e.g., malfunction of the remote termination unit, power outage of system 100, etc.). As another example, movement of a fiber optic cable may correspond to tampering of the fiber optic cable, tampering of the remote termination unit operably coupled to the fiber optic cable (e.g., at an end of the fiber optic cable), or human-movement of components or other activities that cause human-perceivable movement. As a further example, vibrations may correspond to someone or something (e.g., a person, a tool maneuvered by a person or a robot, or an animal) approaching the fiber optic cable, constituting a precursor of the fiber optic cable being tampered or damaged. Merely by way of example, vibration may correspond to minor signal changes within the sampling windows, whereas movements may correspond to more significant changes (e.g., inversions of the peaks to valleys or significant changes to the “shape” of the waveforms within the sampling windows).

In some embodiments, detection subsystem 112 may determine such activities via a prediction model. As an example, the prediction model may be configured to generate a prediction based on the signal reflected across the fiber optic cable to be monitored (e.g., filtered light data falling within sampling windows). In some embodiments, the prediction model may output a binary result indicating whether an activity (e.g., a disturbance activity) related to the fiber optic cable is detected or not. In some embodiments, the prediction model may output a multi-class result including a specific type of activity (e.g., vibration, movement, or unknown) related to the fiber optic cable being detected. In some embodiments, detection subsystem 112 may also include a thresholding determination configured to trigger one or more different downstream actions (e.g., generating alerts about a detected activity, shutting down data transmission through the fiber optic cable where the activity is detected, or performing other actions).

In some embodiments, the prediction model may be based on spectrum fingerprint tracking. That is, the signal reflected across a fiber optic cable to be monitored may remain (substantially) unchanged unless an activity related to the fiber optic cable has occurred, and an activity related to the fiber optic cable may lead to a detected change in the signal reflected across a fiber optic cable to be monitored. Accordingly, the signal reflected across a fiber optic cable may be monitored, and a change thereof may indicate the occurrence of an activity related to the fiber optic cable. In some embodiments, to reduce the computation resource usage or processing time, the monitoring may be performed based on reference positions of sampling windows determined as described elsewhere in the present disclosure, thereby avoiding monitoring over an entire wavelength range reflected across the fiber optic cable or over an entire wavelength range detected by the interrogator.

As an example, the prediction model may include calibration waveforms within the sampling windows. In some embodiments, the prediction model may include at least one analytic model that defines the calibration waveforms. In some embodiments, the prediction model may include discrete data pairs that conform to the calibration waveforms. Each of the data pairs may include a signal intensity and its corresponding wavelength. In some embodiments, the prediction model may include at least one curve representing the calibration waveforms. In some embodiments, detection subsystem 112 may monitor portions of the signal reflected across the fiber optic cable within the sampling windows captured during a detection phase by inputting the portions of the signal falling within the sampling windows into the prediction model. According to the prediction model, the portions of the signal falling within the sampling windows may be compared with the calibration waveforms within the sampling windows. The comparison may be performed at one or multiple wavelengths within each sampling window to provide a deviation value for that sampling window (e.g., an average or a maximum of the deviation values corresponding to multiple wavelengths within the sampling window).

In some embodiments, detection subsystem 112 may detect an activity related to the fiber optic cable based on a deviation of the portions of the signal within the sampling windows from the calibration waveforms within the sampling windows. The deviation may be presented in the form of an absolute value (e.g., a difference between the signal amplitude and the calibration amplitude at corresponding wavelengths within a sampling window), a percentile, or other value. For instance, for each portion of the portions of the signal that respectively fall within the sampling windows, detection subsystem 112 may determine percentage differences between wavelength intensities within the portion of the signal and baseline wavelength intensities of the calibration waveform for the sampling window corresponding to the portion of the signal, and detect, via the prediction model, based on the percentage differences, the activity related to the cable. In some embodiments, the occurrence of the activity may correspond to an average of the changes of the sampling windows exceeding a threshold, or the number (or count) of sampling windows in which the changes exceed the threshold respectively, etc.

As an example, FIG. 7 illustrates an example of activity detection via a prediction model that is based on a spectrum fingerprinting tracking technique. As illustrated in panel I of FIG. 7, in a calibration phase, detection subsystem 112 may receive sensor data corresponding to light signal A1 over a wavelength range reflected by a remote termination unit and across a fiber optic cable to be monitored. In one use case, X (or horizontal) axis of signal A1 is the wavelength (e.g., in nanometers), and the Y (or vertical) axis of signal A1 is signal intensity (or amplitude/power) (e.g., in dBm). Detection subsystem 112 may determine calibration intensity peaks of the reflected light A1 including the calibration intensity peak as indicated by dotted line D1 and dotted line D2, and reference positions of sampling windows B1 and B2 based on the calibration intensity peaks, respectively. The sampling windows B1 and B2 may be separated from each other by a spacing C that is no less than a spacing threshold. Detection subsystem 112 may store the reference positions of sampling windows B1 and B2. In a detection phase (or referred to as an operation phase), detection subsystem 112 may monitor light reflected by the remote termination unit and across a fiber optic cable based on the reference positions of sampling windows B1 and B2. Detection subsystem 112 may detect, via a prediction model, based on the monitoring, an activity related to the fiber optic cable. As shown in panel II of FIG. 7, within sampling window B1, the intensity peak has moved from the position (e.g., wavelength) denoted by D1 in the calibration phase to F in the detection phase. At or in a vicinity of the wavelength corresponding to D1, the signal intensity shows a valley in the detection phase. Within sampling window B2, the intensity peak has moved from the position (e.g., wavelength) denoted by D2 in the calibration phase to H in the detection phase. Accordingly, detection subsystem 112 may determine that an activity related to the fiber optic cable has occurred. That is, the reflected light A2 in panel II of FIG. 7 corresponds to a status of the fiber optic cable after an activity (e.g., a disturbance) related to the fiber optic cable has occurred. The X (or horizontal) axis of signal A2 is the wavelength (e.g., in nanometers), and the Y (or vertical) axis of signal A2 is the signal intensity (or amplitude/power) (e.g., in dBm).

As another example, with respect to FIG. 4, detection subsystem 112 may receive sensor data corresponding to light signal A1 over a wavelength range reflected by two or more termination units on a monitored cable. In one use case, the X (or horizontal) axis of signal A1 is the wavelength (e.g., in nanometers), and the Y (or vertical) axis of signal A1 is signal intensity (or amplitude/power) (e.g., in dBm). Detection subsystem 112 may determine calibration intensity peaks of the reflected light A1 including the calibration intensity peak as indicated by dotted line D1 and dotted line D2 in segment S1 and dotted line D3 and D4 in segment S3, and reference positions of sampling windows B1 and B2 in segment S1 and reference positions of sampling windows B3 and B4 in segment S3, based on the calibration intensity peaks, respectively. The sampling windows B1 and B2 and the sampling windows B3 and B4 may be separated from each other by a spacing that is no less than a spacing threshold. Detection subsystem 112 may store the reference positions of sampling windows B1-B4.

As a further example, in a detection phase (or referred to as an operation phase), detection subsystem 112 may monitor light reflected by the remote termination unit and across a fiber optic cable based on the reference positions of sampling windows B1-B4. In one use case, as shown in FIG. 4B, within sampling window B3, the intensity peak has moved from the position (e.g., wavelength) denoted by D3 in FIG. 3 to another position. Within sampling window B4, the intensity peak has moved slightly from the position (e.g., wavelength) denoted by D4 in FIG. 3 to another position. In some use cases, the foregoing change in FIG. 4B (occurring in the sampling windows in segment S3) may indicate disturbance to a cable that occurs before the location of a termination unit. On the other hand, in another use case, FIG. 4C shows a significant change in both segments S1 and S3 when the cable is manipulated after the location of the termination unit.

In each of the sampling windows B1-B4, the intensity peak has moved as compared to FIG. 4A (e.g., see dotted lines D1-D4 in FIG. 4A vs. FIG. 4C). It should be noted that, in such use cases, when a cable is manipulated before the termination unit, depending on the degree of manipulation, there may be small fluctuations (e.g., “noise”) to the segment S1. Such changes are generally minimal and specific to only a fraction of that monitored spectrum. Because such changes (e.g., resulting from noise) would not satisfy one or more change thresholds (e.g., corresponding to one or more disturbance types), these minor fluctuations/noise may be ignored, thereby reducing false positives. In some use cases, if one or more machine learning techniques described herein is utilized, this noise may be perceptible to and compensated by the machine learning model (e.g., as a result of being trained on training data that includes noise data).

In some embodiments, the prediction model may include a machine learning model. As an example, the prediction model may include multiple machine learning model components each corresponding to a sampling window. In some embodiments, detection subsystem 112 may input filtered light data falling within sampling windows to respective machine learning model components of corresponding sampling windows. In some embodiments, detection subsystem 112 may input filtered light data falling within sampling windows acquired at different times to respective machine learning model components of corresponding sampling windows to determine whether an activity related to the fiber optic cable is detected based on a series of output from the machine learning model components corresponding to these different times.

In some embodiments, the machine learning model (e.g., each of the machine learning model components) may include two-tier detections, machine-learning-based anomaly detection, and a machine-learning-based classification. As an example, detection subsystem 112 may utilize the machine-learning-based anomaly detection to monitor the change in the portion of the filtered light signal for each sampling window and when an anomaly is detected, may forward the filtered light signal to the machine-learning-based classification to label the anomaly (corresponding to an activity related to the fiber optic cable to be monitored) for classification. In some embodiments, the machine-learning-based classification may provide a binary result indicating whether an activity (e.g., a disturbance activity) is detected or not. In some embodiments, the machine-learning-based classification may provide a multi-class result indicating a specific type of activity (e.g., vibration, movement, or unknown) is detected based on changes across the sampling windows.

In one use case, the prediction model may include a convolution neural network (CNN). Detection subsystem 112 may obtain or convert a light signal reflected across a fiber optic cable to be monitored in the form of an image or image feature vectors, and input the image or image feature vectors, with or without pre-processing, into the prediction model for activity detection or classification.

As discussed, the effect of the remote termination unit on a reflected light signal may be random or based on one or more parameters (e.g., the length of the multi-mode fiber in the remote termination unit, other intrinsic or extrinsic parameters of the cable in the remote termination unit, the overall state of the fiber optic cable to be monitored, etc.). This typically calls for a model specific to each cable to be monitored and the interrogation system 106 to be used. Through a variety of normalization or scaling techniques, a common machine learning model applicable to different cables to be monitored or different interrogation systems 106 to be used may be created and applied. As an example, data conversion subsystem 114 may perform difference normalization to determine the rate of change inside of a sampling window in the form of percentage values, thereby creating an automatic normalization of the rate of change to values in a predicable value range (e.g., 0 to 1, −1 to 1) that may be used in machine-learning-based anomaly detection or in classification. As another example, data conversion subsystem 114 may perform scaling on filtered light data falling within sampling windows to account for differences in window widths or reference positions of sampling windows across different fiber optic cables to be monitored or detected using different remote termination units or interrogators. In a use case, data conversion subsystem 114 may perform scaling, based on one or more window size criteria, and portions of filtered light data such that the scaled portions are more similar to one another with respect to the window size criteria than before the scaling. As illustrated in FIGS. 5A and 5B, the scaled signal in FIG. 5B retains a waveform similar to the original waveform in FIG. 5A, while the wavelength range and the amplitude of the scaled signal are one-half of those of the original signal. Data conversion subsystem 114 may perform scaling according to basic scaling/matrix formulas based on respective common sampling windows so that detection subsystem 112 may input the scaled portions of the signal acquired from a specific fiber optic cable into the prediction model (e.g., respective machine learning model components) to obtain a prediction result regarding an activity related to the fiber optic cable.

In some embodiments, model subsystem 116 may train or configure one or more detection or other prediction models to facilitate one or more embodiments described herein. In some embodiments (including where one or more interrogators 502 are used to capture a light signal reflected across a fiber optic cable), machine learning techniques may be used in one or more embodiments to detect anomalies or perform classification. In some embodiments, the prediction models may include supervised or unsupervised machine learning models. In some embodiments, the prediction models may include reinforced learning models (e.g., continuously updated via a continuous learning process). As an example, model subsystem 116 may facilitate a feedback loop process that provides options for the upstream system or user to provide classification information (e.g., labels) that may be used by model subsystem 116 to better classify events in the future or add support for new event types. The model training or configuration may be performed online (e.g., as part of the calibration phase of an actual use case of fiber optic cable monitoring). The model training or configuration may be performed offline before an actual use case of fiber optic cable monitoring, and a trained or configured model may be stored in or accessible by detection subsystem 112 when needed.

In some embodiments, the prediction models may include one or more neural networks. As an example, neural networks may be based on a large collection of neural units (or artificial neurons). Neural networks may loosely mimic the manner in which a biological brain works (e.g., via large clusters of biological neurons connected by axons). Each neural unit of a neural network may be connected with many other neural units of the neural network. Such connections may be enforcing or inhibitory in their effect on the activation state of connected neural units. In some embodiments, each individual neural unit may have a summation function that combines the values of all its inputs together. In some embodiments, each connection (or the neural unit itself) may have a threshold function such that the signal must surpass the threshold before it propagates to other neural units. These neural network systems may be self-learning and trained, rather than explicitly programmed, and may perform significantly better in certain areas of problem solving, as compared to traditional computer programs. In some embodiments, neural networks may include multiple layers (e.g., where a signal path traverses from front layers to back layers). In some embodiments, backpropagation techniques may be utilized by the neural networks, where forward stimulation is used to reset weights on the “front” neural units. In some embodiments, stimulation and inhibition for neural networks may be more free-flowing, with connections interacting in a more chaotic and complex fashion.

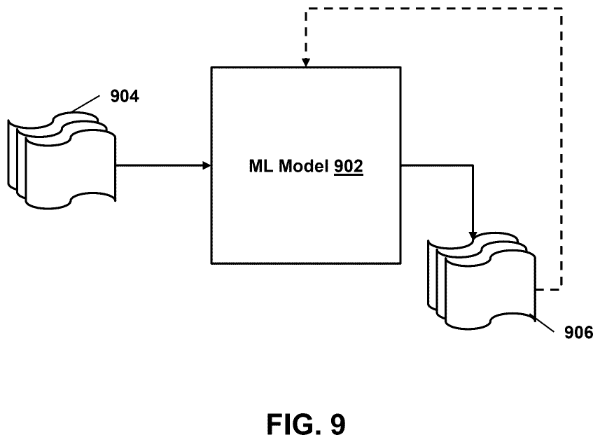

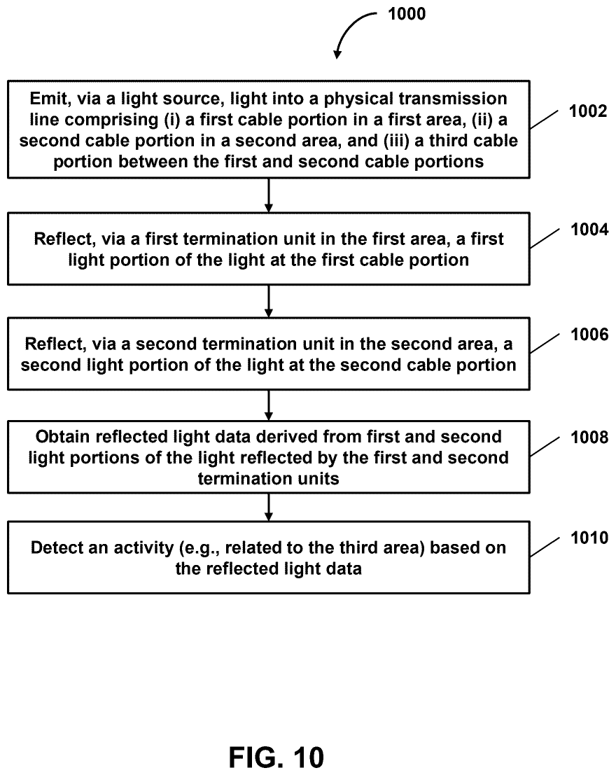

As an example, with respect to FIG. 9, machine learning model 902 may take inputs 904 and provide outputs 906. In one use case, outputs 906 may be fed back to machine learning model 902 as input to train machine learning model 902 (e.g., alone or in conjunction with user indications of the accuracy of outputs 906, with labels associated with the inputs, or with other reference feedback information). In another use case, machine learning model 902 may update its configurations (e.g., weights, biases, or other parameters) based on its assessment of its prediction (e.g., outputs 906) and reference feedback information (e.g., user indication of accuracy, reference labels, or other information). In another use case, where machine learning model 902 is a neural network, connection weights may be adjusted to reconcile differences between the neural network's prediction and the reference feedback. In a further use case, one or more neurons (or nodes) of the neural network may require that their respective errors be sent backward through the neural network to them to facilitate the update process (e.g., backpropagation of error). Updates to the connection weights may, for example, be reflective of the magnitude of error propagated backward after a forward pass has been completed. In this way, for example, the machine learning model 902 may be trained to generate better predictions.

As an example, where the prediction models include a neural network, the neural network may include one or more input layers, hidden layers, and output layers. The input and output layers may respectively include one or more nodes, and the hidden layers may each include a plurality of nodes. When an overall neural network includes multiple portions trained for different objectives, there may or may not be input layers or output layers between the different portions. The neural network may also include different input layers to receive various input data. Also, in differing examples, data may be input to the input layer in various forms, and in various dimensional forms, input to respective nodes of the input layer of the neural network. In the neural network, nodes of layers other than the output layer are connected to nodes of a subsequent layer through links for transmitting output signals or information from the current layer to the subsequent layer, for example. The number (or count) of the links may correspond to the number of the nodes included in the subsequent layer. For example, in adjacent fully connected layers, each node of a current layer may have a respective link to each node of the subsequent layer, noting that in some examples such full connections may later be pruned or minimized during training or optimization. In a recurrent structure, a node of a layer may be again input to the same node or layer at a subsequent time, while in a bidirectional structure, forward and backward connections may be provided. The links are also referred to as connections or connection weights, as referring to the hardware-implemented connections or the corresponding “connection weights” provided by those connections of the neural network. During training and implementation, such connections and connection weights may be selectively implemented, removed, and varied to generate or obtain a resultant neural network that is thereby trained and that may be correspondingly implemented for the trained objective, such as for any of the above example recognition objectives.

In some embodiments, the prediction models may include one or more large language models (LLMs), large multimodal models (LMMs), or other models involving one or more transformer architectures. LLMs are trained on extensive text corpora and may generate human-like text based on given prompts. These models use transformer architectures, which rely on attention mechanisms to weigh the importance of different input tokens, allowing the model to capture context over long sequences of data. LMMs combine textual and visual information to enhance the model's ability to understand and generate multimodal content. These models integrate information from diverse data sources, enabling them to perform complex tasks such as image captioning, visual question answering, and cross-modal retrieval. During training, the models learn to adjust their internal parameters, such as weights and biases, through processes like backpropagation and gradient descent. These adjustments help minimize the error between the model's predictions and the actual outcomes, improving the model's accuracy over time.

In some embodiments, model subsystem 116 may associate events (or other activities) to specific times and based on user-initiated options, may observe/record these events over a defined time period (e.g., X hours, X days, X weeks, etc.) and automatically adjust the thresholds before generating and sending alerts or other event notifications to one or more administrators or other users. Such dynamic thresholds may include (i) a change threshold with respect to an amount of change within a given wavelength range (e.g., a required amount of difference from a baseline within a single sampling window, a required amount of difference from the baseline collectively across multiple sampling windows within the wavelength range, etc.), (ii) a threshold number of sampling windows in which such a change satisfying the change threshold occurs at a given time (e.g., two or more sampling windows for wavelengths shorter than the shortest wavelength of the reference wavelength range, two or more sampling windows for wavelengths longer than a longest wavelength of the reference wavelength range, etc.), or (iii) other thresholds. Examples include heating and air conditioning units (HVAC), power generators, motors, vehicles, elevators, and equipment fans. In some embodiments, the types of signals that are monitored may be adjusted. As an example, model subsystem 116 may modify one or more “tuning” parameters (e.g., via user input or without any user input specifying the particular modification). Some examples of such modifications include: modifying which signals are included in determining the definition of an “activity,” modifying the degree of change for each signal, modifying the weight of the degree of change for each signal, modifying the number of concurrent signals changes in X time that constitute an event, or other modifications. However, the signals that are to be included in activity detection may be modified by the user. In another use case, one or more change thresholds may be used to adjust the value at which a signal is determined to have changed a significant amount. In another use case, weighting of the degree of change may be modified to reduce the impact of one or more signals over another. As another use case, two or more signal changes within one second may be classified as an event sent to the user or upstream system.

In one use case, the prediction model may include a convolution neural network (CNN). Detection subsystem 112 may obtain or convert a light signal reflected across a fiber optic cable to be monitored in the form of an image or image feature vectors, and input the image or image feature vectors, with or without pre-processing, to the prediction model for activity detection or classification. The CNN may include an input layer, a convolutional layer, an activation function, a pooling layer, a fully connected layer, and an output layer. The input layer may be configured to receive the input data, such as an image or an audio signal, in the form of a grid or matrix. In this case, input for machine learning may be in the form of an image or image feature vectors. In some embodiments, data conversion subsystem 114 may convert a signal (e.g., filtered light data) into a set of image feature vectors.

In some embodiments, data conversion subsystem 114 may, before the conversion, pre-process each of the heterogenous signals acquired from different sets of equipment (e.g., fiber optic cables to be monitored, remote termination units, interrogators, etc., from different manufacturers/brands and having different specifications), as discussed elsewhere herein (e.g., by scaling or performing other normalization techniques on the signals). In some embodiments, data conversion subsystem 114 may then convert each pre-processed signal into a set of image feature vectors to be used as input for training CNN. In the convolutional layer, local patterns, such as edges or textures, may be detected by applying convolution operations between the input and a set of filters (also known as kernels). These filters may have a smaller spatial extent than the input and slide across the input data to create feature maps that represent the presence of specific patterns. After the convolution operation, an activation function, such as a Rectified Linear Unit (RcLU), may be applied to introduce non-linearity into the network, enabling it to learn more complex patterns. The pooling layer may reduce the spatial dimensions of the feature maps, which in turn may reduce the number (or count) of parameters and computational cost while preserving information of interest. Example pooling techniques include max pooling and average pooling. After multiple convolutional and pooling layers, the feature maps may be flattened and connected to a fully connected layer. This layer may facilitate the combination of the features learned by the previous layers and make predictions based on the input data. The output layer may provide a final output of the CNN, such as a prediction of whether an activity related to the fiber optic cable is detected or classification of the activity.

In some embodiments, model subsystem 116 may train a machine learning model based on a training dataset of images or other light-derived data (e.g., filtered light emitted via a physical transmission line) to generate predictions related to one or more activities. Such training datasets may be stored in or retrieved from training data database(s) 134 of prediction database(s) 132. As an example, the machine learning may be provided with an input (e.g., a signal including filtered light data detected in a calibration phase without a disturbance activity or in a detection phase with a disturbance activity) and generate the predictions as an output. As another example, each input may include filtered light data (e.g., a vector representation of the filtered light data).

As still a further example, model subsystem 116 may train or configure a prediction model based on a CNN algorithm. In this case, input for machine learning may be in the form of an image or image feature vectors. In some embodiments, data conversion subsystem 114 may convert a signal (e.g., filtered light data) into a set of image feature vectors. As an example, data conversion subsystem 114 may, before the conversion, pre-process each of the heterogenous signals acquired from different sets of equipment (e.g., fiber optic cables to be monitored, remote termination units, interrogators, etc., from different manufacturers/brands and having different specifications), as discussed elsewhere herein (e.g., by scaling or performing other normalization techniques on the signals). Data conversion subsystem 114 may then convert each pre-processed signal into a set of image feature vectors to be used as input for training CNN.

In some embodiments, after obtaining filtered light data, data conversion subsystem 114 may obtain one or more vector representations related to the filtered light data (e.g., via one or more encoders). Model subsystem 116 may use one or more machine learning models to obtain one or more respective predictions (e.g., a set of predicted activities and respective confidence scores associated with the predicted activities) that are used to assess whether such activities (e.g., an intrusion event or other adverse event) occurred. In one use case, when devices (e.g., laser source, collection devices, etc.) are manufactured with similar components, have similar tolerances for filter distances and other similar characteristics, etc., a common prediction model (e.g., a common machine learning model) may be used. In this way, for example, the machine learning machines may be trained or configured with training data derived from devices (e.g., collection devices) having the same manufacturer (or a few different manufacturers), but still be usable to accurately generate predictions for data derived from devices created by a larger set of different manufacturers.

In some embodiments, prior to generating the vector representations of the filtered light data (and providing the vector representations to a machine learning model), data conversion subsystem 114 may transform the filtered light data based on a device identifier, a device type, a manufacturer identifier, or device configuration information associated with the laser source or the interrogator (e.g., used to facilitate detection of a signal of reflected light). As an example, data conversion subsystem 114 may transform signals captured by interrogators from different manufacturers such that the signals have similar waveform traits. Thus, for example, the set of devices (e.g., collection devices) from which data may be obtained (e.g., to create training datasets for machine learning machines) may be further expanded to devices from additional manufacturers and still be useable to accurately generate predictions for data derived from devices created by a larger set of different manufacturers.

In some embodiments, model subsystem 116 may provide one or more services (e.g., cloud-based services) through which new machine learning models (or updated versions thereof) may be obtained and provided to one or more users (e.g., customer systems that use such activity detection systems). In some embodiments, raw data captured by the different devices (e.g., by different manufacturers) may be obtained and used to train or configure one or more machine learning models or other prediction models. As discussed above, even when there are differences across devices and manufacturers, the raw data may be transformed into a normalized form (e.g., where the resulting images have similar focal point boundaries, positions/sizes, and similar second “outer” boundaries). This may allow contributions toward a larger or more comprehensive model that may be shared by a community of users.

As another example, data conversion subsystem 114 may pre-process heterogeneous signals including filtered light data acquired from different sets of equipment (e.g., fiber optic cables to be monitored for different intrinsic or extrinsic parameters, remote termination units, interrogators, etc., from different manufacturers/brands and having different specifications). In some embodiments, data conversion subsystem 114 may pre-process such signals before being input to the machine learning, thereby allowing heterogenous signals acquired by different equipment or interrogation devices or systems to be used as training datasets. Such training datasets may be stored in training data database(s) 134 of prediction database(s) 132. As discussed, normalization may determine the rate of change inside of a sampling window in the form of percentage values, thereby creating an automatic normalization of the rate of change to values in a predicable value range (e.g., 0 to 1, −1 to 1) that may be used as input for machine learning. Filtered light data falling within sampling windows may be scaled to account for differences in window widths or reference positions of sampling windows of signals of light reflected across different fiber optic cables to be monitored or detected by different equipment including different remote termination units or different interrogators.

In some embodiments, a small number of common prediction models may be created. In some embodiments, the common prediction models may be stored in model database(s) 136 of prediction database(s) 132. As an example, different prediction models may be created for different spectrum sampling capabilities of interrogators (e.g., sampling capacities of wavelength ranges of 35 nm, 80 nm, or 160 nm). Such a difference in sampling capacity may limit the number (or count) of sampling windows to be monitored, which in turn may affect detection performance. As another example, different prediction models may be created for different speeds of sampling, resolution, or accuracy of the spectrum measurement of interrogators. Such differences may cause a failure to detect changes to the light signal reflected across a fiber optic cable to be monitored when the cable is handled briefly (e.g., within a time period shorter than a time interval between consecutive sampling) or a significant reduction in the degree of change measured during an activity (e.g., disturbance) related to the fiber optic cable.

In one use case, each input may be associated with a label (e.g., intrusion, cable movement, signal loss, normal activity, vibration, or other label), and the machine learning may generate a multi-class label prediction as the output. The label prediction may be fed back to the machine learning model as input along with the actual associated label (or other reference feedback) to train the machine learning model. In another use case, the machine learning model may update its configurations (e.g., weights, biases, or other parameters) based on its assessment of its prediction and the reference feedback information. In another use case, where the machine learning model is a neural network, connection weights may be adjusted to reconcile differences between the neural network's prediction and the reference feedback.

It should be noted that, in some embodiments, multiple predictions may be obtained respectively from multiple machine learning models or other non-machine-learning models. In some embodiments, each of the machine learning models and the non-machine-learning models may be trained or configured for predictions derived from different types of data (e.g., different types of disturbances, different types of events, different data formats, etc.).

In some embodiments, a first machine learning model may be trained or configured to generate predictions based on one or more types of disturbances, and a first statistical model may be trained or configured to generate predictions based on one or more event types. As an example, the first machine learning model may be trained or configured to detect human-perceivable movement or non-oscillating movement and oscillating motion (e.g., vibrations). As another example, the first statistical model may be trained or configured to detect signal loss (e.g., an absence of signal) that may be determined through simple color analysis. By using a non-machine-learning model for detections/predictions for one or more activities (e.g., in combination with machine learning models for detections/predictions for one or more other activities), computer resource usage along with the corresponding processing time may be reduced (e.g., as compared with using only machine learning models to detect all activities).

In some embodiments, system 100 may be integrated with a variety of network devices to offer alarm detection and alarm response capabilities. In some embodiments, system 100 may integrate with Passive Optical Network (PON) equipment, Optical Circuit Switch equipment, Optical Test Access Point equipment, and Network Analyzers to stop and start data flow to one or more network endpoints, re-route data flow, and record or further analyze data when alarms are detected and resolved. Additionally or alternatively, system 100 may integrate with at least one of a Network Time Protocol (NTP) for time synchronization of the hardware's operating system to other components within the overall architecture in which system 100 is deployed, Simple Mail Transport Protocol (SMTP) for system or activity notifications via email, Terminal Access Controller Access Control System (TACACS) for secure login/management of the system, or a network monitoring or security system via a protocol such as Syslog, MQTT, or Modbus. In some embodiments, system 100 may handle the coordination of tasks between dark fiber alarm monitoring devices and PON equipment through backend adapters leveraging Simple Network Management Protocol (SNMP) traps and Secure Shell (SSH) protocols. In some embodiments, system 100 may provide the ability for complete network mapping of components starting from a source Optical Line Terminal (OLT) down to an end user Optical Network Terminal (ONT).

In some embodiments, detection subsystem 112 may cause shutdown of network dataflow to one or more network endpoints proximate to a detected disturbance on a physical transmission line. As an example, detection subsystem 112 may monitor the physical information transmission line. When detection subsystem 112 has detected a disturbance on the physical information transmission line (e.g., based on techniques described herein via the interrogation systems 106a-106n or via one or more other sensors), detection subsystem 112 may trigger a network data flow shutdown response. As a further example, detection subsystem 112 may determine a location of the detected disturbance on the physical transmission line, and initiate shutdown of the network data flow to the network endpoints proximate to the determined location of the detected disturbance (e.g., the network endpoints within a threshold number of connections or distance of the detected disturbance). In one scenario, the initiation of the shutdown of the network data flow may include transmitting a port disabling command to a data flow control switch to disable a port associated with the network endpoints, rerouting at least a portion of the network data flow to avoid the network endpoints, or other actions.

In some embodiments, detection subsystem 112 may store activity information based on one or more criteria. Such criteria may include a user configuration (e.g., only x days of events or x number of events), physical storage capacity (e.g., disk, flash card, memory, etc.), or other criteria. Activity recording may allow the storage of activity information in the event that detection subsystem 112 is disconnected from an upstream software management system or interruptions in communications need synchronization of events with an upstream software management system.

### Example Flowcharts

FIG. 4 is an example flowchart of processing operations of a method 400 that enable the various features and functionality of the system as described in detail above. The processing operations of the method presented below are intended to be illustrative and non-limiting. In some embodiments, for example, the method may be accomplished with one or more additional operations not described and/or without one or more of the operations discussed. Additionally, the order in which the processing operations of the method are illustrated (and described below) is not intended to be limiting.

In some embodiments, the method may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on an electronic storage medium. The processing devices may include one or more devices configured through hardware, firmware, and/or software to be specifically designed for execution of one or more of the operations of the methods.

In operation 1002, light may be emitted into a physical transmission line via a light source. The light source may be a laser or any other suitable light-emitting device. The physical transmission line may include a fiber optic cable that is being monitored. The transmission line may be divided into portions located in different areas. For example, a first cable portion of the transmission line may be located in a first area, which may be a secure or trusted location (e.g., a server room, a control center, etc.). A second cable portion of the transmission line may be located in a second area, which may also be a secure location (e.g., another server room, a different control center, any other location where the integrity of the transmission line is considered secure, etc.). Between these two trusted areas, a third cable portion of the transmission line may be located in a third area, which may be an untrusted or potentially vulnerable location where the security of the transmission line may not be as secure as the two trusted areas. As an example, the third area may be a public area, a stretch of cable that runs outside a secure building, or other location where there is a greater risk of the transmission line being tampered or accessed in an unauthorized manner, as compared to the two trusted areas. In some use cases, in addition to the three cable portions, the transmission line may also include one or more other cable portions located in other areas. The other areas may be additional trusted areas, untrusted areas, or areas with varying levels of security or vulnerability. Operation 1002 may be performed by a subsystem that is the same as or similar to detection subsystem 112 (e.g., by controlling an interrogator or other device that includes the light source), in accordance with one or more embodiments.

In operation 1004, a first light portion of the light (e.g., at the first cable portion located in the first area) may be reflected toward the light source via a first termination unit in the first area. The first termination unit may be configured to interact with the incoming light, capturing the first light portion, and reflecting the first light portion towards the light source. The reflected light carries information about any changes or disturbances that have occurred along the cable, which may then be analyzed to detect any potential issues or threats. In some embodiments, this process of reflection and data capture is continuous, allowing for real-time monitoring and detection of activities along the transmission line.

In some embodiments, the first termination unit may include a first splitter (e.g., configured to allow the second light portion of the light to pass through the first termination unit to the third cable portion located in the third area), a first sensor (e.g., that receives the first light portion from the first splitter), a first coiled cable (e.g., configured to receive at least some light of the first light portion that passes through the first sensor), or other components. In some embodiments, reflecting the first light portion may include: causing, via the first splitter of the first termination unit, the second light portion of the light to pass through the first termination unit to the third cable portion (between the first and second cable portions); and reflecting, via the first sensor of the first termination unit, toward the light source, at least a first part of the first light portion received at the first sensor. Additionally, or alternatively, reflecting the first light portion may include reflecting, via the first coiled cable of the first termination unit, toward the light source, a second part of the first light portion that passes through the first sensor.

In some embodiments, the first coiled cable of the first termination unit may be a multi-mode cable (e.g., that has two or more coils, six or more coils, etc.). While multi-mode cables are not designed to be used as a reflector because multi-mode cables cause optical signals to become dispersed as they travel along the cable (e.g., which may cause signal distortion and loss of signal quality), the seemingly “negative” effects of the signal dispersion (e.g., signal distortion, loss of signal quality, etc.) also cause any changes to or around the vicinity of the monitored cable or its connected components to become more detectable by components of system 100.

In operation 1006, a second light portion of the light at the second cable portion may be reflected toward the light source via a second termination unit in the second area. The second termination unit may be configured to interact with the incoming light, capturing the second light portion, and reflecting the second light portion towards the light source. As with the reflected first light portion, the reflected light carries information about any changes or disturbances that have occurred along the cable, which may then be analyzed to detect any potential issues or threats.

In some embodiments, the second termination unit may include a second sensor (e.g., that receives the second light portion), a second coiled cable (e.g., configured to receive at least some light of the second light portion that passes through the second sensor), or other components. In some embodiments, reflecting the second light portion may include reflecting, via the second sensor of the second termination unit, at least a first part of the second light portion received at the first sensor. Additionally, or alternatively, reflecting the second light portion may include reflecting, via the second coiled cable of the second termination unit, a second part of the second light portion that passes through the second sensor. In some embodiments, as with the first coiled cable of the first termination unit, the second coiled cable of the second termination unit may be a multi-mode cable (e.g., that has two or more coils, six or more coils, etc.). As discussed above, the multi-mode cable along with the coiling of the cable will cause optical signals to become dispersed as they travel along the cable, thereby resulting in any changes to or around the vicinity of the monitored cable or its connected components to become more detectable by components of system 100.

In operation 1008, reflected light data may be obtained. As an example, the reflected light data may be derived from the first light portion of the light and the second light portion of the light (e.g., where the first light portion is reflected back by a first termination unit in the first area, and the second light portion is reflected back by the second termination unit in the second area). The reflected light data provides a comprehensive view of the state of the transmission line and its surroundings. By analyzing reflected light data, system 100 may accurately detect and locate disturbances or activities along the length of the transmission line, thereby enhancing the accuracy and reliability of a monitoring system. Operation 1008 may be performed by a subsystem that is the same as or similar to detection subsystem 112, in accordance with one or more embodiments.

In operation 1010, an activity may be detected based on the reflected light data. As an example, an activity related to the third area may be detected based on the reflected light data. In some embodiments, a prediction model may be used to detect the activity in the third area. The prediction model may analyze the reflected light data (or portions thereof) to identify patterns or changes that may indicate activity in the third area. Any changes in the reflected light data, such as shifts in the intensity or wavelength of the reflected light, may indicate a disturbance as well as an area in which the disturbance occurred (e.g., the third area). As an example, the prediction model may be trained to recognize these changes and make accurate predictions about the type of activity and the given area in which the activity occurred. In this way, where the transmission line spans across both trusted and untrusted areas, system 100 is enabled to accurately detect intrusions or other disturbances in the untrusted area while reducing false alarms that may be generated by activity in the trusted areas. Operation 1010 may be performed by a subsystem that is the same as or similar to detection subsystem 112 or data conversion subsystem 114, in accordance with one or more embodiments.

In some embodiments, with respect to the reflected light data (e.g., associated with a first time period during which the reflected first light portion and the reflected second light portion are respectively reflected by the first and second termination units), detecting the activity may include determining that a first wavelength range of the reflected light data and a second wavelength range of the reflected light data satisfy the change threshold. As an example, based on this determination, a first disturbance-related alert may be generated for the third area (e.g., the untrusted area). In one use case, the first disturbance-related alert may specify that a disturbance activity occurred in the third area during the first time period.

In some embodiments, if one or more ranges of wavelengths with respect to a given time period are determined to not satisfy the change threshold, generation of a disturbance-related alert related to the given time period may be avoided. As an example, despite one wavelength range of reflected light data related to the given time period satisfying a predetermined change threshold, generation of a disturbance-related alert related to the given time period may be avoided based on the determination that another wavelength range of the reflected light data does not satisfy the change threshold. In some embodiments, with respect to a reference wavelength range (e.g., associated with one or more sensors of termination units), a model may indicate that no disturbance has been detected during the given time period (or a disturbance-related alert for the given time period may be suppressed) based on a determination that a particular wavelength range of the reflected light data (e.g., shorter than a shortest wavelength of the reference wavelength range) does not satisfy the change threshold, despite a determination that a second wavelength range of the reflected light data (e.g., longer than a longest wavelength of the reference wavelength range) satisfies the change threshold.

In one scenario, where the first and second termination units respectively generate chirp spectrums (e.g., as part of reflecting the first and second light portions), some embodiments may determine whether a disturbance activity occurred in the third area between the first and second area (or whether such activity occurred in the first or second area) based on (i) first changes occurring in a first wavelength range shorter than wavelengths of the chirp spectrums (e.g., shorter than a shortest wavelength of the chirp spectrums) and (ii) second changes occurring in a second wavelength range longer than wavelengths of the chirp spectrums (e.g., longer than a longest wavelength of the chirp spectrums). Some embodiments may determine that no disturbance activity occurred in the third area (e.g., by determining that the detected activity instead occurred in the first or second area) in response to the first changes in the first range of shorter wavelengths not satisfying the change threshold, despite the second change in the second range of longer wavelengths satisfying the change threshold.

In some embodiments, detecting the activity may include determining two or more wavelength ranges of the reflected light data that are shorter than a shortest wavelength of a reference wavelength range (e.g., a wavelength range associated with one or more sensors of termination units), and detecting a disturbance related to the third area based on (i) respective changes in the determined wavelength ranges satisfying a change threshold and (ii) the respective changes collectively occurring within a threshold number of two or more sampling windows (e.g., predetermined sampling windows for wavelengths shorter than the shortest wavelength of the reference wavelength range).

Some embodiments may filter the reflected light data based on a determination of one or more wavelengths (or wavelength ranges) corresponding to reflections of one or more components, and detect an activity based on (i) the filtered reflected light data and (ii) reference positions for sampling windows for the filtered reflected light data. As an example, some embodiments may determine (i) sensor-reflected wavelengths respectively corresponding to broadband reflections of a first sensor of the first termination unit and a second sensor of the second termination unit or (ii) coiled-cable-reflected wavelengths respectively corresponding to reflections of a first coiled cable of the first termination unit and a second coiled cable of the second termination unit. Such embodiments may filter the reflected light data based on the sensor-reflected wavelengths or the coiled-cable-reflected wavelengths such that the filtered reflected light excludes the sensor-reflected wavelengths and includes the coiled-cable-reflected wavelengths, and then perform activity detection based on the filtered reflected light data and the reference positions.

As discussed, some embodiments may include detecting the activity via one or more machine learning models or other prediction models. Some embodiments may include adjusting the parameters or settings of the models based on observed changes in the reflected light data. For example, if a shift is detected in the patterns or trends in the reflected light data, it may adjust the parameters or settings of the models accordingly, thereby helping to ensure that the models remain effective in detecting disturbances (e.g., even as the conditions in the untrusted area change over time).

Some embodiments may employ a time-based analysis to associate events to specific times and adjust the threshold at which the system will send event notifications. This time-based analysis may be particularly useful in environments where a monitored transmission line is subject to disturbances that occur at specific time intervals. For example, in some cases, a fiber optic cable may be located near sources of movement or vibration, such as heating and air conditioning units, power generators, motors, vehicles, or equipment fans, that operate at predictable times. By associating events to these specific times, the system may be able to distinguish between disturbances caused by these known sources and disturbances that may indicate an intrusion in an untrusted area. Some embodiments may be configured to observe and record events over a defined time period, such as a specific number of hours, days, or weeks. This observation period may be user-defined, allowing for customization based on the specific characteristics of the environment or the detection preferences of the user. During this observation period, the system may monitor the reflected light data and identify any patterns or trends that correspond to disturbances occurring at specific times. Based on this time-based analysis, the system may adjust the thresholds at which it will send event notifications. For instance, if a pattern of disturbances occurs at a specific time each day, the system may adjust one or more thresholds to account for these expected disturbances and avoid generating false positives. This adjustment may involve increasing a threshold during the times when these expected disturbances occur, such that the system will not send an event notification unless the change in the reflected light data exceeds this higher threshold. Conversely, during times when no expected disturbances are occurring, the system may lower the threshold, allowing for more sensitive detection of potential intrusions.

Some embodiments may also involve one or more machine learning models trained to recognize patterns in the reflected light data that correspond to disturbances occurring at specific times. Such machine learning models may be used in conjunction with the time-based analysis to further enhance the accuracy and reliability of the system's intrusion detection capabilities. For instance, a machine learning model may be trained to recognize the specific patterns of change in the reflected light data that correspond to the expected disturbances, and to distinguish these patterns from patterns that may indicate an intrusion, thereby enabling the system to accurately detect intrusions even in environments with regular sources of disturbance.

In some embodiments, the various computers and subsystems illustrated in FIG. 1 may include one or more computing devices that are programmed to perform the functions described herein. The computing devices may include one or more electronic storages (e.g., prediction database(s) 132, which may include training data database(s) 134, model database(s) 136, etc., or other electronic storages), one or more physical processors programmed with one or more computer program instructions, and/or other components. The computing devices may include communication lines or ports to enable the exchange of information within a network (e.g., network 150) or other computing platforms via wired or wireless techniques (e.g., Ethernet, fiber optics, coaxial cable, WiFi, Bluetooth, near-field communication, or other technologies). The computing devices may include a plurality of hardware, software, and/or firmware components operating together. For example, the computing devices may be implemented by a cloud of computing platforms operating together as the computing devices.

The electronic storages may include non-transitory storage media that electronically stores information. The storage media of the electronic storages may include one or both of (i) system storage that is provided integrally (e.g., that is substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent processing functionality of a plurality of devices operating in coordination. The processors may be programmed to execute computer program instructions to perform functions described herein of subsystems 112-116 or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems 112-116 described herein is for illustrative purposes and is not intended to be limiting, because any of subsystems 112-116 may provide more or less functionality than is described. For example, one or more of subsystems 112-116 may be eliminated, and some or all of its or their functionality may be provided by other subsystems of subsystems 112-116. As another example, additional subsystems may be programmed to perform some or all of the functionality attributed herein to one of subsystems 112-116.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

The present techniques will be better understood with reference to the following enumerated embodiments:
1. A method to facilitate detecting an activity related to a first area, second area, or third area based on reflected light from a physical transmission line comprising (i) a first cable portion in a first area, (ii) a second cable portion in a second area, and (iii) a third cable portion between the first cable portion and the second cable portion and in a third area, the method comprising: configuring the physical transmission line to include a first termination unit in the first area and a second termination unit in the second area to obtain the reflected light data (e.g., by connecting the first and second termination units along the physical transmission line), wherein the first termination unit is configured to reflect a first light portion of light emitted into the physical transmission line back toward a light source and allow a second light portion of the light to continue past the first termination unit along the physical transmission line, and wherein the second termination unit is configured to reflect the second light portion back toward the light source.
2. A method comprising: causing transmission of light into a physical transmission line (e.g., comprising one or more cables or other components) comprising (i) a first cable portion in a first area, (ii) a second cable portion in a second area, and (iii) a third cable portion between the first cable portion and the second cable portion and in a third area; obtaining reflected light data derived from a first light portion of the light and a second light portion of the light, wherein the first light portion is reflected back by a first termination unit in the first area, and the second light portion is reflected back by a second termination unit in the second area; and detecting an activity (e.g., related to the first, second, or third area) based on the reflected light data derived from the reflected first light portion and the reflected second light portion.
3. The method of the preceding embodiment, wherein the first termination unit comprises a first splitter that allows the second light portion of the light to pass through the first termination unit to the third cable portion between the first cable portion and the second cable portion.
4. The method of any of the preceding embodiments, wherein the first termination unit comprises a first sensor (e.g., FBG sensor or other sensor) or reflective filter that reflects a first part of the first light portion (e.g., back toward a light source of the light).
5. The method of any of the preceding embodiments, wherein the first termination unit comprises a first coiled cable (e.g., a coiled multi-mode cable) or distortion mirror that reflects a second part of the first light portion (e.g., that passes through the first sensor of the first termination unit).
6. The method of any of the preceding embodiments, wherein the second termination unit comprises a second sensor (e.g., FBG sensor or other sensor) or reflective filter that reflects a first part of the second light portion (e.g., back toward a light source of the light).
7. The method of any of the preceding embodiments, wherein the second termination unit comprises a second coiled cable (e.g., a coiled multi-mode cable) or distortion mirror that reflects a second part of the second light portion (e.g., that passes through the second sensor of the second termination unit).
8. The method of any of the preceding embodiments, wherein the second termination unit comprises a second splitter that allows a third light portion of the light to pass through the second termination unit (e.g., to another cable portion after the second area).
9. The method of any of the preceding embodiments, further comprising: determining that a first wavelength range of prior reflected light data corresponding to prior light portions reflected during a prior time period does not satisfy a change threshold and a second wavelength range of the prior reflected light data satisfies the change threshold; and despite the second wavelength range of the prior reflected light data satisfying the change threshold, avoiding generation of a disturbance-related alert corresponding to the prior time period based on the determination that the first wavelength range of the prior reflected light data does not satisfy the change threshold.
10. The method of any of the preceding embodiments, further comprising: with respect to the reflected light data associated with a first time period during which the reflected first light portion and the reflected second light portion are respectively reflected by the first termination unit and the second termination unit, determining that the first wavelength range of the reflected light data and the second wavelength range of the reflected light data both satisfy the change threshold; and generating a first disturbance-related alert based on the determination that both the first wavelength range of the reflected light data and the second wavelength range of the reflected light data satisfy the change threshold.
11. The method of any of the preceding embodiments, further comprising: with respect to a reference wavelength range associated with one or more sensors of the first or second termination units, determining that a first wavelength range of the reflected light data shorter than a shortest wavelength of the reference wavelength range satisfies a change threshold and a second wavelength range of the reflected light data longer than a longest wavelength of the reference wavelength range satisfies the change threshold, wherein detecting the activity comprises detecting, via the prediction model, a disturbance activity related to the third area based on the determination that both the first wavelength range of the reflected light data and the second wavelength range of the reflected light data satisfy the change threshold.
12. The method of any of the preceding embodiments, further comprising: detecting respective changes occurring in two or more wavelength ranges of the reflected light data (e.g., that are shorter than a shortest wavelength of a reference wavelength range associated with one or more sensors of the first or second termination units, that are longer than a longest wavelength of the reference wavelength range, etc.), wherein detecting the activity comprises detecting, via the prediction model, a disturbance activity (e.g., related to the first, second, or third area) based on (i) the respective changes satisfying a change threshold and (ii) the respective changes collectively occurring within a threshold number of two or more sampling windows (e.g., sampling windows for wavelengths shorter than the shortest wavelength of the reference wavelength range).
13. The method of any of the preceding embodiments, further comprising: determining (i) sensor-reflected wavelengths respectively corresponding to broadband reflections of a first sensor of the first termination unit and a second sensor of the second termination unit or (ii) coiled-cable-reflected wavelengths respectively corresponding to reflections of a first coiled cable of the first termination unit and a second coiled cable of the second termination unit; filtering the reflected light data based on the sensor-reflected wavelengths or the coiled-cable-reflected wavelengths such that the filtered reflected light excludes the sensor-reflected wavelengths and includes the coiled-cable-reflected wavelengths; and determining reference positions for sampling windows for the filtered reflected light data, wherein detecting the activity comprises detecting, via the prediction model, the activity based on the filtered reflected light data and the reference positions for the sampling windows.
14. The method of the preceding embodiment 11, wherein the reference positions for the sampling windows are based on local characteristic extrema at different wavelengths of previous light reflected across the physical transmission line such that (i) each window of the sampling windows comprises a corresponding wavelength of a local characteristic extremum of the local characteristic extrema and (ii) the sampling windows collectively do not comprise other wavelengths of the previous light between at least two of the sampling windows of the wavelength range.
15. The method of any of the preceding embodiments 11-12, wherein determining the reference positions comprises determining the reference positions for the sampling windows based on a spacing threshold such that each sampling window of the sampling windows is separated by at least the spacing threshold from a next sampling window of the sampling windows closest to the sampling window.
16. The method of any of the preceding embodiments 11-13, wherein determining the reference positions comprises: detecting local characteristic extrema at different wavelengths of previous light reflected across the physical transmission line; and for each local intensity extremum of the local intensity extrema, determining the corresponding wavelength of the local intensity extremum; and determining the reference positions of a sampling window by positioning the corresponding wavelength at a center of the sampling window.
17. The method of any of the preceding embodiments 11-14, wherein each window of the sampling windows is a sampling of a different number of wavelengths than at least one other window of the sampling windows.
18. The method of any of the preceding embodiments 11-15, wherein detecting the activity comprises: monitoring a signal reflected across the physical transmission line by extracting, based on the reference positions for the sampling windows, a portion of the signal that falls within the sampling windows; and inputting the extracted portion of the signal to the prediction model to obtain a prediction indicating the activity.
19. The method of any of the preceding embodiments, wherein detecting the activity comprises detecting the activity specific to the first, second, or third area based on the reflected light data derived from the reflected first light portion and the reflected second light portion.
20. The method of any of the preceding embodiments, wherein detecting the activity comprises detecting the activity related to an untrusted area, the third area being the untrusted area.
21. The method of any of the preceding embodiments, wherein the first and second areas are trusted areas, and the third area is not a trusted area.
22. The method of any of the preceding embodiments, wherein the first and second areas are each an area within a locked room.
23. The method of any of the preceding embodiments, wherein the third area is a public area.
24. The method of any of the preceding embodiments, wherein the first termination unit comprises a coiled cable having a first cable core size different than a cable core size of a cable of the physical transmission line, the coiled cable of the first termination unit reflecting at least some light back toward a slight source of the light.
25. The method of any of the preceding embodiments, wherein the second termination unit comprises a coiled cable having a first cable core size different than a cable core size of a cable of the physical transmission line, the coiled cable of the second termination unit reflecting at least some light back toward a light source of the light.
26. The method of any of the preceding embodiments, wherein the first or second termination unit comprises a coiled cable configured to have six or more coils (e.g., the cable is coiled within the termination unit six or more times).
27. The method of any of the preceding embodiments, wherein the first or second termination unit comprises a coiled cable that is 0.3 m or greater (e.g., 0.5 m or greater, 0.6 m or greater, 0.6-1 m, 0.6-2 m, 0.6-3 m, 1 m or greater, 2 m or greater, 3 m or greater, etc.).
28. The method of any of the preceding embodiments, wherein the first termination unit is configured to reflect a first signal such that the reflected first signal has a first highest peak (e.g., amplitude of the wave or magnitude of power) that is higher than all other peaks (e.g., amplitude) in the reflected first signal.
29. The method of any of the preceding embodiments, wherein a first sensor of the first termination unit is configured to reflect a first signal such that the reflected first signal has a first highest peak (e.g., amplitude of the wave or magnitude of power) with a first width greater than widths of all other peaks (e.g., altitude of power) in the reflected first signal.
30. The method of any of the preceding embodiments, wherein a first sensor of the first termination unit is configured to reflect a first part of a first signal such that the reflected first part of the first signal has a first highest peak (e.g., amplitude of the wave or magnitude of power) with a first width greater than widths of all peaks (e.g., amplitude of the wave or magnitude of power) in another part of the first signal reflected by a first coiled cable of the first termination
31. The method of any of the preceding embodiments, wherein the second termination unit is configured to reflect a second signal such that the reflected second signal has a second highest peak (e.g., amplitude of the wave or magnitude of power) with a second width greater than widths of all other peaks (e.g., amplitude of the wave or magnitude of power) in the reflected second signal.
32. The method of any of the preceding embodiments, wherein a second sensor of the second termination unit is configured to reflect a second signal such that the reflected second signal has a first second peak (e.g., amplitude of the wave or magnitude of power) with a second width greater than widths of all other peaks (e.g., amplitude of the wave or magnitude of power) in the reflected second signal.
33. The method of any of the preceding embodiments, wherein a second sensor of the second termination unit is configured to reflect a first part of a second signal such that the reflected first part of the second signal has a second highest peak (e.g., amplitude of the wave or magnitude of power) with a second width greater than widths of all peaks (e.g., amplitude of the wave or magnitude of power) in another part of the second signal reflected by a second coiled cable of the second termination unit.
34. The method of any of the preceding embodiments, wherein the first and second termination units are separated by over three meters of cable, over ten meters of cable, over fifty meters of cable, over one hundred meters of cable, over two hundred meters of cable, over three hundred meters of cable, over a kilometer of cable, over five kilometers of cable, over ten kilometers of cable, over twenty kilometers of cable, over fifty kilometers of cable, a length of cable between two or more of the foregoing lengths (e.g., a length of cable between one hundred to three hundred meters, a length of cable between five to fifty kilometers, etc.), or other length of cable (e.g., with no other termination units, configured to reflect light back toward the light source, in between the first and second termination units along the cable line).
35. One or more tangible, non-transitory, machine-readable media storing instructions that, when executed by one or more processors, cause the one or more processors to perform operations comprising those of any of the foregoing method embodiments.
36. A system comprising: one or more processors; and memory storing instructions that, when executed by the processors, cause the processors to effectuate operations comprising those of any of the foregoing method embodiments.

What is claimed is:

1. A system for facilitating fiber optic cable monitoring while avoiding false positives derived from disturbance occurring in a trusted area, the system comprising:
a light source coupled to a first end of a monitored fiber optic cable, wherein light emitted from the light source travels through (i) a first cable portion of the monitored fiber optic cable that is located in a first trusted area, (ii) a second cable portion of the monitored fiber optic cable that is located in a second trusted area, and (iii) one or more cable portions of the monitored fiber optic cable that is located in an untrusted area and between the first cable portion and the second cable portion;
a first remote termination unit located in the first trusted area and configured to reflect a first spectral portion of the light at the first cable portion toward the light source and allow a second spectral portion of the light to pass through the first remote termination unit to the one or more cable portions located in the untrusted area;
a second remote termination unit located in the second trusted area and configured to reflect the second spectral portion of the light at the second cable portion toward the light source; and
one or more processors programmed with computer program instructions that, when executed, cause operations comprising:
obtaining reflected light data derived from the reflected first spectral portion reflected by the first remote termination unit and the reflected second spectral portion reflected by the second remote termination unit; and
detecting, via a prediction model, a disturbance activity related to the untrusted area based on the reflected light data derived from the reflected first spectral portion and the reflected second spectral portion.

2. The system of claim 1, where the first remote termination unit located in the first trusted area comprises (i) a splitter configured to allow the second spectral portion of the light to pass through the first remote termination unit to the one or more cable portions located in the untrusted area, (ii) an embedded sensor that receives the first spectral portion from the splitter, and (iii) a coiled multi-mode cable configured to receive at least some light of the first spectral portion that passes through the embedded sensor.

3. The system of claim 1, wherein detecting the disturbance activity comprises:
filtering the reflected light data based on a first chirp spectrum generated by the first remote termination unit and a second chirp spectrum generated by the second remote termination unit; and
detecting, via the prediction model, the disturbance activity related to the untrusted area based on the filtered reflected light.

4. The system of claim 1, wherein detecting the disturbance activity comprises:
detecting, based on chirp spectrums respectively generated by the first remote termination unit and generated by the second remote termination unit, (i) first changes occurring in a first wavelength range shorter than a shortest wavelength of the chirp spectrums and (ii) second changes occurring in a second wavelength range longer than a longest wavelength of the chirp spectrums; and
detecting, via the prediction model, the disturbance activity related to the untrusted area based on the first changes occurring in the first wavelength range and the second changes occurring in the second wavelength range.

5. A method comprising:
emitting, via a light source, light into a physical transmission line comprising (i) a first cable portion in a first area, (ii) a second cable portion in a second area, and (iii) a third cable portion between the first cable portion and the second cable portion and in a third area;
reflecting, via a first termination unit in the first area, a first light portion of the light at the first cable portion toward the light source;
reflecting, via a second termination unit in the second area, a second light portion of the light at the second cable portion toward the light source; and
detecting, via a prediction model, an activity related to the third area based on reflected light data derived from the reflected first light portion and the reflected second light portion.

6. The method of claim 5, wherein reflecting the first light portion comprises:
causing, via a splitter of the first termination unit, the second light portion of the light to pass through the first termination unit to the third cable portion between the first cable portion and the second cable portion;
reflecting, via a first sensor of the first termination unit, toward the light source, a first part of the first light portion received at the first sensor; and
reflecting, via a first coiled cable of the first termination unit, toward the light source, a second part of the first light portion that passes through the first sensor of the first termination unit.

7. The method of claim 6, wherein reflecting the second light portion comprises:
reflecting, via a second sensor of the second termination unit, toward the light source, a first part of the second light portion received at the second sensor; and
reflecting, via a second coiled cable of the second termination unit, toward the light source, a second part of the second light portion that passes through the second sensor of the second termination unit.

8. The method of claim 5, further comprising:
determining that a first wavelength range of prior reflected light data corresponding to prior light portions reflected during a prior time period does not satisfy a change threshold and a second wavelength range of the prior reflected light data satisfies the change threshold; and
despite the second wavelength range of the prior reflected light data satisfying the change threshold, avoiding generation of a disturbance-related alert corresponding to the prior time period based on the determination that the first wavelength range of the prior reflected light data does not satisfy the change threshold.

9. The method of claim 5, further comprising:
determining (i) sensor-reflected wavelengths respectively corresponding to broadband reflections of a first sensor of the first termination unit and a second sensor of the second termination unit or (ii) coiled-cable-reflected wavelengths respectively corresponding to reflections of a first coiled cable of the first termination unit and a second coiled cable of the second termination unit;
filtering the reflected light data based on the sensor-reflected wavelengths or the coiled-cable-reflected wavelengths such that the filtered reflected light excludes the sensor-reflected wavelengths and includes the coiled-cable-reflected wavelengths; and
determining reference positions for sampling windows for the filtered reflected light data,
wherein detecting the activity related to the third area comprises detecting, via the prediction model, the activity related to the third area based on the filtered reflected light data and the reference positions for the sampling windows.

10. The method of claim 9, wherein detecting the activity related to the third area comprises:
monitoring a signal reflected across the physical transmission line by extracting, based on the reference positions for the sampling windows, a portion of the signal that falls within the sampling windows; and
inputting the extracted portion of the signal to the prediction model to obtain a prediction indicating the activity.

11. One or more non-transitory computer-readable media storing instructions that, when executed by one or more processors, cause operations comprising:
causing transmission of light into a physical transmission line comprising (i) a first cable portion in a first area, (ii) a second cable portion in a second area, and (iii) a third cable portion between the first cable portion and the second cable portion and in a third area;
obtaining reflected light data derived from a first light portion of the light and a second light portion of the light, wherein the first light portion is reflected back by a first termination unit in the first area, and the second light portion is reflected back by a second termination unit in the second area; and
detecting, via a prediction model, an activity related to the first area, the second area, or the third area based on the reflected light data derived from the reflected first light portion and the reflected second light portion.

12. The one or more non-transitory computer-readable media of claim 11, wherein the first termination unit comprises a splitter that allows the second light portion of the light to pass through the first termination unit to the third cable portion between the first cable portion and the second cable portion, a sensor that reflects a first part of the first light portion, and a first coiled cable that reflects a second part of the first light portion that passes through the sensor of the first termination unit.

13. The one or more non-transitory computer-readable media of claim 11, the operations further comprising:
determining that a first wavelength range of prior reflected light data corresponding to prior light portions reflected during a prior time period does not satisfy a change threshold and a second wavelength range of the prior reflected light data satisfies the change threshold; and
despite the second wavelength range of the prior reflected light data satisfying the change threshold, avoiding generation of a disturbance-related alert corresponding to the prior time period based on the determination that the first wavelength range of the prior reflected light data does not satisfy the change threshold.

14. The one or more non-transitory computer-readable media of claim 13, the operations further comprising:
with respect to the reflected light data associated with a first time period during which the reflected first light portion and the reflected second light portion are respectively reflected by the first termination unit and the second termination unit, determining that the first wavelength range of the reflected light data and the second wavelength range of the reflected light data both satisfy the change threshold; and
generating a first disturbance-related alert based on the determination that both the first wavelength range of the reflected light data and the second wavelength range of the reflected light data satisfy the change threshold.

15. The one or more non-transitory computer-readable media of claim 11, the operations further comprising:
with respect to a reference wavelength range associated with one or more sensors of the first or second termination units, determining that a first wavelength range of the reflected light data shorter than a shortest wavelength of the reference wavelength range satisfies a change threshold and a second wavelength range of the reflected light data longer than a longest wavelength of the reference wavelength range satisfies the change threshold,
wherein detecting the activity comprises detecting, via the prediction model, a disturbance activity related to the third area based on the determination that both the first wavelength range of the reflected light data and the second wavelength range of the reflected light data satisfy the change threshold.

16. The one or more non-transitory computer-readable media of claim 11, the operations further comprising:
detecting respective changes occurring in two or more wavelength ranges of the reflected light data that are shorter than a shortest wavelength of a reference wavelength range associated with one or more sensors of the first or second termination units,
wherein detecting the activity comprises detecting, via the prediction model, a disturbance activity related to the third area based on (i) the respective changes satisfying a change threshold and (ii) the respective changes collectively occurring within a threshold number of two or more sampling windows for wavelengths shorter than the shortest wavelength of the reference wavelength range.

17. The one or more non-transitory computer-readable media of claim 11, the operations further comprising:
determining (i) sensor-reflected wavelengths respectively corresponding to broadband reflections of a first sensor of the first termination unit and a second sensor of the second termination unit or (ii) coiled-cable-reflected wavelengths respectively corresponding to reflections of a first coiled cable of the first termination unit and a second coiled cable of the second termination unit;
filtering the reflected light data based on the sensor-reflected wavelengths or the coiled-cable-reflected wavelengths such that the filtered reflected light excludes the sensor-reflected wavelengths and includes the coiled-cable-reflected wavelengths; and
determining reference positions for sampling windows for the filtered reflected light data,
wherein detecting the activity comprises detecting, via the prediction model, the activity based on the filtered reflected light data and the reference positions for the sampling windows.

18. The one or more non-transitory computer-readable media of claim 17, wherein the reference positions for the sampling windows are based on local characteristic extrema at different wavelengths of previous light reflected across the physical transmission line such that (i) each window of the sampling windows comprises a corresponding wavelength of a local characteristic extremum of the local characteristic extrema and (ii) the sampling windows collectively do not comprise other wavelengths of the previous light between at least two of the sampling windows.

19. The one or more non-transitory computer-readable media of claim 17, wherein determining the reference positions comprises determining the reference positions for the sampling windows based on a spacing threshold such that each sampling window of the sampling windows is separated by at least the spacing threshold from a next sampling window of the sampling windows closest to the sampling window.

20. The one or more non-transitory computer-readable media of claim 17, wherein determining the reference positions comprises:
detecting local characteristic extrema at different wavelengths of previous light reflected across the physical transmission line; and
for each local intensity extremum of the local intensity extrema,
determining the corresponding wavelength of the local intensity extremum; and
determining the reference positions of a sampling window by positioning the corresponding wavelength at a center of the sampling window.
